(19) United States
(12) Patent Application Publication
(10) Pub. No.: US 2016/0108243 A1
(43) Pub. Date: Apr. 21, 2016

(54) SUSTAINABLE COMPOSITIONS, RELATED METHODS, AND MEMBERS FORMED THEREFROM

(71) Applicant: Andersen Corporation, Bayport, MN (US)

(72) Inventors: Michael James Deaner, Osceola, WI (US); Keith James Effertz, Lake Elmo, MN (US); Patrick Jerome Gronlund, Somerset, WI (US); Larry Michael Morelli, Stillwater, MN (US); Matthew John Sedivy, Osceola, WI (US); Paul Steven Bischoff, Stillwater, MN (US)

(21) Appl. No.: 14/971,419

(22) Filed: Dec. 16, 2015

Related U.S. Application Data
(62) Division of application No. 13/049,222, filed on Mar. 16, 2011.
(60) Provisional application No. 61/314,356, filed on Mar. 16, 2010.
(60) Provisional application No. 61/323,561, filed on Apr. 13, 2010.
(60) Provisional application No. 61/413,029, filed on Nov. 12, 2010.

(51) Int. Cl. C08L 97/02; C08L 67/04; B29C 47/92; B29C 47/00; B29C 47/80

(52) U.S. Cl. CPC C08L 97/02; B29C 47/0004; B29C 47/80; B29C 47/92; C08L 67/04; B29C 2947/92704; B29C 2947/92857; B29K 2067/046

(57) ABSTRACT

Members including components of windows and doors are formed by a method that includes obtaining a biopolymer and a filler, feeding them into an extruder, controlling at least the temperature of the biopolymer and the filler within the extruder to promote the initiation of nucleation of the biopolymer, extruding the composite through a die of the extruder to form an extruded member and controlling at least the cooling rate of the extruded member after it leaves the die to promote crystallization of the biopolymer. Methods are disclosed for compounding and pelletizing as well as direct extrusion of the composite. In a preferred embodiment, the biopolymer is polylactic acid (PLA) and the filler is wood fiber. In addition, neat PLA formulations are also disclosed. Further, the heat distortion temperature and the hydrolysis resistance of these members are greatly increased through specific processing conditions and the addition of strategic quantities of additives.

### RELATED APPLICATIONS

This application is a divisional of U.S. application Ser. No. 13/049,222, filed on Mar. 16, 2011, which claims the benefit of U.S. Application Ser. No. 61/314,356, filed on Mar. 16, 2010 and U.S. Application Ser. No. 61/323,561, filed on Apr. 13, 2010, and U.S. Application Ser. No. 61/413,029, filed on Nov. 12, 2010, the contents of which are herein incorporated by reference in their entireties.

### TECHNICAL FIELD

This disclosure relates generally to compositions and methods and more specifically to structural or decorative members such as window and door components, for example, that are made with biopolymers such as polylactic acid (PLA). Disclosed among other things are compositions and members made therefrom as well as methods of compounding the compositions, methods of enhancing properties of the compositions, and methods of processing the compositions into structural or decorative members.

### BACKGROUND

Structural and decorative members made by extrusion of polymeric materials are well known in the building industry. For example, many parts of windows, doors, railings, decking, siding, flooring, fencing, trim, and the like are produced by extrusion of polymers such as polyvinyl chloride (PVC) or composites made of PVC and fillers such as wood fiber, other organic and inorganic fillers, binders, and/or reinforcing materials. Other thermoplastic polymers, such as polyethylene, polypropylene, and acrylonitrile butadiene styrene (ABS), along with a variety of thermoset polymers, have also been found useful. A common reinforcing material is wood particulate, in the form of sawdust, though other filler or reinforcing materials may also be used. A common filler material is wood fiber, though other fillers or reinforcing materials may also be used. The extruded members may comprise more than one layer, such as a coextruded outer layer or capping layer that covers an inner base extrusion. Such capping layers may serve to improve weatherability or appearance of the base extrusion or provide an outer surface of a desired texture or character. Capping material may, for example, impart a particular color to some or all of portions of extruded members. It is also common practice to provide capping layers on only part of an extruded member, or to provide two or more different capping layers to different parts of an extruded member.

PVC, like many other polymers, has been found to be a useful and very successful polymer for many extruded construction and structural and decorative members because, in part, of its resistance to deterioration and its durability. However, it nevertheless may have some perceived environmental disadvantages. For example, PVC, which is a petroleum derived polymer, is not generally considered a sustainable material in that it is not produced from a renewable resource. A more sustainable class of polymers with less of an environmental impact is the class known as biopolymers such as polyesters derived from renewable resources, of which PLA is an example. PLA can be produced by fermentation of corn or other renewable resources, and degrades to relatively harmless substances after its useful life when deposited in a landfill or other waste location. PLA may also be depolymerized into lactic acid and repolymerized after appropriate processing to allow more economically viable recycling into a wide variety of useful products, thereby reducing the disposal burden. PLA is thus recyclable as well as being renewable. It will be understood that while this disclosure is couched primarily in terms of PLA, PLA composites, and compounding and extrusion methodologies, the term biopolymer should be construed to include and encompass all polymers derived from renewable resources, including PLA.

While PLA has proven useful for certain products such as the manufacture of textiles, cups, snack chip bags, and the like, it has been found to suffer significant performance limitations for use in other applications. In particular, PLA's sensitivity to high temperatures, and particularly its relatively low heat distortion temperature (HDT), has made PLA and PLA composites unsuitable for use in most building construction and other components that may be exposed to the elements. This shortcoming and others have generally restricted the use of PLA for such applications. In addition, like other polyesters, PLA is prone to degradation by hydrolysis, especially at elevated temperatures and humidity levels. This inherent aspect of PLA makes it prone to deterioration over time and has further limited its use as a component of structural or decorative members that will be exposed to the elements. Also, like other polyesters, adhesion of other polymers or coatings to the surface of PLA may be difficult to achieve.

It is known that PLA can be crystallized, and that increased crystallinity can raise the heat distortion temperature of the material. It is also known, however, that the speed of crystallization of PLA is relatively low, which may limit its value in situations where high throughput, coupled with high crystallinity, that is to say rapid crystallization, is needed. This combination of requirements can occur, for example, where structural and decorative members are to be produced by extrusion, and the required crystallization rate is therefore dictated by the line speed of the extrusion process. Such line speeds typically have been far too fast to allow PLA to crystallize before cooling. An additional problem can arise due to the fact that PLA has a rather sharply defined melting point. This can place strict requirements on temperature control and die design in an extruder, and it may be difficult to produce an extruded member from PLA that retains its shape well during cooling.

### SUMMARY

The disclosures of the provisional patent applications to which priority is claimed above are hereby incorporated by reference in their entirety.

A need exists for a method of compounding and extruding or otherwise processing PLA or other biopolymers for use in structural and decorative members that will be exposed to the elements and that need to last extended periods of time under such exposure. A need also exists for a method of compounding and extruding PLA or other biopolymers that forms structural or decorative members that will be exposed to the elements and that need to last extended periods of time under such exposure. Such structural and decorative members may include, for instance, components for windows and doors, railings, decking, siding, flooring, fencing, trim, and other building products. A particular need exists for fenestration components such as window and door components such as jambs, sills, frames, rails, stiles, extenders, grilles, trim, mull posts, panels and other accessories or components to be made with PLA or other biopolymers that retain sufficient strength at elevated temperatures and that resist hydrolysis and other deterioration for extended periods of time. It will be understood throughout this disclosure that reference to a “member” or any one or more of the specific members mentioned above as well as the terms “structural members” or “decorative members” includes and encompasses all of the above applications. There is a need for PLA compositions (and other biopolymer compositions) and production techniques that enable viable members for the applications specified herein. It is to the provision of PLA compositions, methods of enhancing their properties, methods of compounding them, and methods of extruding and capping them that meet the above and other needs that the present disclosure is primarily directed.

Briefly described, biopolymer-based compositions, compounding methods, extrusion methods, capping methods and members extruded or otherwise formed therefrom are disclosed. Further, methodologies for significantly enhancing properties such as heat distortion temperature and hydrolysis resistance of such compositions and members so that they are suitable for exposure to the elements for extended periods of time are disclosed. More specifically, in the exemplary embodiments, a process for extruding an improved formulation of a composition, including a composite containing PLA and wood fiber, is disclosed. Additives, treatments, and extrusion conditions have been discovered for increasing crystallization during extrusion, and thus greatly increasing the heat distortion temperature of the resulting extruded members. The process involves, among other things, controlling the conditions and temperature of the composition at various stages of the extrusion process to match time-temperature profiles that the inventors have discovered promote rapid nucleation of PLA crystals and promotes further crystallization of the PLA. The use of a filler such as wood fiber in the composition has been found to help the extruded member retain its shape after exiting from the extrusion die, thereby simplifying temperature control downstream of the extruder. Resulting extruded members having heat distortion temperatures in excess of 100° Celsius (212° Fahrenheit) have been obtained. Field experience with window and door products has shown that components having such heat distortion temperatures may perform significantly better in warmer environments than petroleum-based polymers currently in use. The present disclosure includes improved formulations for significantly enhancing the resistance of resulting extrusions to hydrolysis and the deterioration that it causes, thereby rendering such extrusions suitable for use in members such as window and door components to be exposed to the environment.

Formulations for capping material, methods to apply the capping material to underlying base extrusions made of the disclosed PLA compositions and for overcoming the inherent difficulty of bonding such capping material to a PLA composition are also disclosed. The inventors have discovered that coextruding a capping material over a base extrusion comprising PLA with a filler such as wood fiber can improve various properties of resulting extruded PLA-filler composite members. It has been found for instance that the presence of the capping material has a surprisingly significant effect on such properties as flexural modulus and heat shrink tolerance of extruded members formed of the composite. Thus, a method of extruding members from PLA-filler composites that results in a member useful for members such as window and door components is disclosed.

As used herein, the term neat PLA formulation will refer to a PLA polymer that does not contain fillers, but may or may not contain additives, such as heat or UV stabilizers, colorants, nucleating agents, process aids and hydrolysis inhibitors. As used herein, the term process aid will include any additives for improving the processing of the formulation. Such additives may include metal release agents, lubricants, viscosity modifiers, additives for improving melt strength in extrusion, as well as other additives. Process aids can function in a variety of ways, sometimes modifying the polymer, and sometimes depositing onto various surfaces that the polymer contacts during processing, or both. In some cases, process aids may function in more than one way, for example as a lubricant and as a metal release agent. Examples of process aids include waxes, stearates, such as calcium stearate, and polymeric materials. It is contemplated that there may be examples wherein satisfactory results may be obtained without one or more of the disclosed additives.

More broadly, production methods for forming members from PLA composites and also neat PLA formulations suitable for exposure to the environment for an extended period of time are disclosed. Compositions of matter with PLA and various fillers and additives suitable for making such members are disclosed, as are a variety of members extruded from the compositions.

The invention further encompasses compositions of matter including, for example, the following combinations or compositions, extruded into or for extrusion into a structural or decorative member for use, for example, in the construction industry.

(a) 10% to 90% PLA in combination with 90% to 10% wood fiber.

(b) Composition (a) in combination with additives

(c) Composition (a) where the wood fiber begins as pellets

(d) Composition (a) where the wood fiber begins as flour

(e) Composition (a) where the PLA comprises a stereo complex

(f) Composition (a) and further including 10% to 90% of a capstock material

(g) composition comprising a combination of one or more of:
PLA
poly-D-lactide
poly-L-lactide
fillers
additives
capstock
wood flour
wood fiber
sawdust
botanic fiber
lubricants
compatibilizers,
polymer blends

Thermoplastic polymers for use in the formation of members are disclosed, as are various categories of biopolymers such as plant-oil based biopolymers, protein based biopolymers, fermentation based biopolymers, polyesters derived from renewable resources, and PLA. Although a mixture of biopolymer and petroleum based polymers materials is considered less commercially desirable, formulations containing, for example, 75% or more biopolymer mixed with a petroleum based polymers such as acrylic, a family of synthetic or man-made plastic materials containing one or more derivatives of acrylic acid, are possible and within the scope of the invention. Members made with PLA containing no fillers, having a ratio of PLA to filler of 100/0, are also disclosed. However, it has been found that a preferred ratio of weight percent PLA to weight percent filler such as wood fiber is between about 50/40 and 60/40 depending upon the weight percentages of other additives used.

Although any number of fillers can be used to make the composite, lignocellulose fibers, such as wood fiber, are the preferred materials. Wood fiber can be sourced from hardwoods and/or softwoods. Other biomaterials or other organic materials may also be used as fillers. As used herein, the term biomaterial will refer to materials of biological origin, such as wood fiber, hemp, kenaf, bamboo, rice hulls, and nutshells. More generally, other lignocellulose materials resulting from agricultural crops and their residues may also be used as fillers. Other biomaterials, including proteinaceous materials such as poultry feathers, may also find application in some instances. Other organic materials, such as carbon black, carbon fiber, and the like may also be used as fillers. Other polymeric materials such as thermosetting materials or composites thereof in particulate form may also find application. In addition, inorganic particulate materials such as metal oxide particles or spheres, glass particles, short glass fibers, or other like materials may be used. These fillers may be used either alone or in combination with other organic or inorganic fillers. The fillers may be treated in various ways to improve adhesion to the polymeric materials, reduce moisture effects, or provide other useful properties.

Further, while compounding and pelletizing in a separate process is the preferred method for manufacturing the material to be extruded, direct extrusion by allowing the components to mix in the primary extruder prior to melting, thereby forming a blend, is also disclosed and is within the scope of the invention.

This is presented within the context of profile extrusion as a manufacturing technique for forming PLA into members and PLA composites into members, although other manufacturing techniques such as extrusion over other materials, such as wood, compression molding and sheet molding may be applied. The disclosure also is couched primarily within the context of the fabrication of window and door members, although the discussed methodologies may be applied to other applications such as railings, decking, siding, flooring, fencing, trim, and other building products. In particular, window and door components such as jambs, sills, frames, rails, stiles, extenders, grilles, trim, mull posts and panels; siding components such as siding, trim, soffit, fascia and shakes; decking components such as decking, posts, trim, rails and balusters and other building components are within the scope of the invention.

As mentioned above, members co-extruded with a capping layer are preferred, especially for use in window and door components. Capping of extrusions can provide many advantages, including improved crystallinity and, in some cases, improved hydrolysis resistance. It is contemplated that the improvements in capping provided for PLA-filler composites will also apply, to some degree, to neat PLA formulations. Disclosed capping materials may comprise PVC, acrylic and other polymers. These capping materials have been found to provide varying levels of resistance to moisture transmission. When co-extruded over the PLA compositions the capping material can act as a moisture barrier that in turn increases the base PLA composition's resistance to hydrolysis. Uncapped structures made of the disclosed compositions also may be appropriate in certain situations, such as interior components of a window or door.

Techniques for increasing significantly the heat distortion temperature of PLA compositions are disclosed. The inventive techniques raise the heat distortion temperature of members formed from PLA compositions to 100° Celsius (212° Fahrenheit) or greater, which is suitable for use as members for window and door applications. However, for uses where temperatures are less of a concern, the target heat distortion temperature of the composition may be less, such as between 80° Celsius (176° Fahrenheit) and 100° Celsius (21.2° Fahrenheit) or even less than 80° Celsius (176° Fahrenheit). Finally, the inventors have developed techniques and formulations for increasing the hydrolysis resistance of members made of PLA compositions to 18 times or more that of a PLA composition that does not contain a hydrolysis inhibitor. It is believed that such enhancement of hydrolysis resistance may he sufficient to permit resulting members to withstand exposure to the elements for extended periods of time.

These and other aspects, features, and advantages of these and other methodologies, compositions, formulations, and members disclosed herein will become more apparent upon review of the detailed description set forth below when taken in conjunction with the accompanying drawing figures, which are briefly described as follows.

### BRIEF DESCRIPTION OF THE DRAWINGS

FIG. 1 is a schematic illustration of an extruder arrangement used to compound and pelletize a PLA-wood composite for use in a subsequent extrusion process.

FIG. 2 is a schematic illustration of the primary and co-extruder arrangement used to produce the extruded members tested according to the disclosure.

FIG. 3 is a cross-sectional view illustrating a generic simplified hollow profile of a member extruded according to the disclosure.

FIG. 4 is a cross-sectional view illustrating a capped hollow profile of a member extruded with different capping materials on different surfaces according to the disclosure.

FIG. 5 is a graph illustrating results of testing and showing the relationship between flexural modulus and density for a variety of sample profiles.

FIG. 6 is a graph illustrating results of testing and showing the relationship between tensile modulus and density for a variety of sample profiles.

FIG. 7 is a graph illustrating results of testing and showing the relationship between heat shrink and density for a variety of sample profiles.

FIG. 8 is a graph illustrating results of testing and showing the relationship between density and extruder motor current draw for a variety of sample profiles.

FIG. 9 is a graph illustrating results of testing and showing the relationship between density and extruder motor current draw for a variety of sample profiles.

FIG. 10 is a graph of flexural modulus versus capping thickness for a variety of capped sample profiles.

FIG. 11 is a graph of tensile modulus versus capping thickness for a variety of capped sample profiles.

FIG. 12 is a graph of heat shrink versus capping thickness for a variety of capped sample profiles.

FIG. 13 is a graph of density versus capping thickness for a variety of capped sample profiles.

FIG. 14 is a simplified diagrammatic illustration of a device used by the inventors to measure heat distortion temperature of samples.

FIG. 15 is a cross-sectional view illustrating a capped hollow profile of a member formed according to the disclosure.

FIG. 16 is a graph of flexural strength versus complex viscosity for an extruded uncapped sample.

FIG. 17 is a graph of flexural strength versus complex viscosity for an extruded capped sample.

FIG. 18 is a graph of complex viscosity versus hours of exposure to 82° Celsius (180° F.), 90% relative humidity for an extruded neat PLA formulation sample with a 1% hydrolysis inhibitor additive.

FIG. 19 is a graph of complex viscosity versus hours of exposure to 82° Celsius (180° F.), 90% relative humidity for an extruded PLA-wood composite sample with a 1% hydrolysis inhibitor additive.

FIG. 20 is a graph of complex viscosity versus hours of exposure to 82° Celsius (180° F.), 90% relative humidity for an extruded neat PLA formulation sample with a 2.5% hydrolysis inhibitor additive.

FIG. 21 is a graph of complex viscosity versus hours of exposure to 82° Celsius (180° F.), 90% relative humidity for an extruded PLA-wood composite sample with a 2.5% hydrolysis inhibitor additive.

FIG. 22 is a graph of complex viscosity versus hours of exposure to 82° Celsius (180° F.), 90% relative humidity for an extruded neat PLA formulation sample with a 5% hydrolysis inhibitor additive.

FIG. 23 is a graph of complex viscosity versus hours of exposure to 82° Celsius (180° F.), 90% relative humidity for an extruded PLA-wood composite sample with a 5% hydrolysis inhibitor additive.

FIG. 24 is a graph showing hours to 50% complex viscosity at 88° Celsius (190° F.) and 90% relative humidity as a function of percent of a hydrolysis inhibitor additive for neat PLA formulation samples.

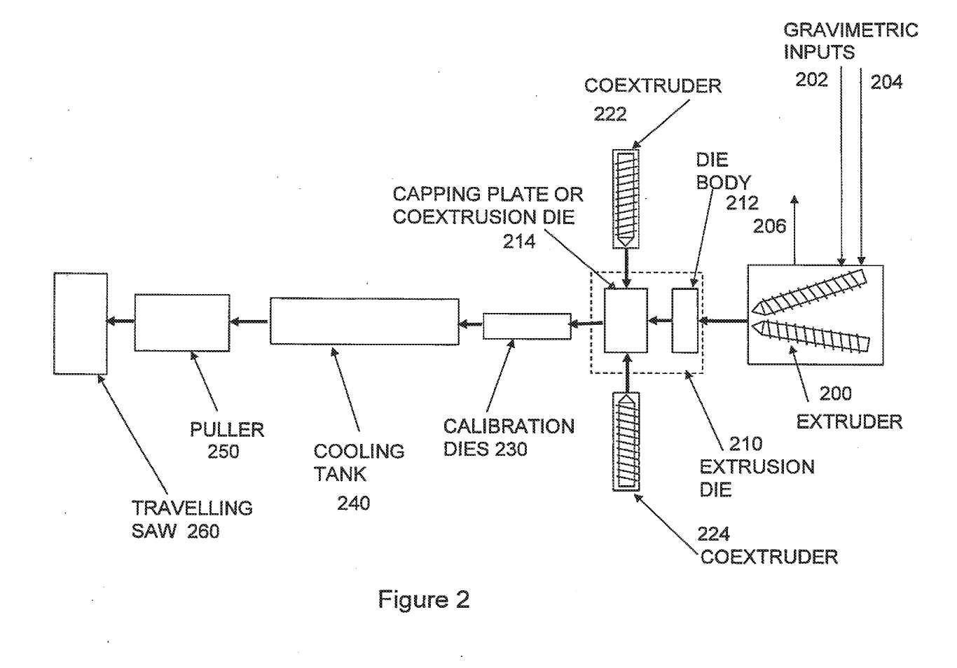

FIG. 2.5 is a graph showing hours to 50% complex viscosity at 88° Celsius (190° F.) and 90% relative humidity as a function of percent of a hydrolysis inhibitor additive for PLA-wood composite samples.

FIG. 26 is a graph of complex viscosity versus hours of exposure to 60° Celsius (140° F.) and 90% relative humidity for a PLA-wood composite sample with a 2.5% hydrolysis inhibitor additive.

FIG. 27 is a graph of complex viscosity versus hours of exposure to 60° Celsius (140° F.) and 90% relative humidity for a PLA-wood composite sample with a hydrolysis inhibitor additive.

### DETAILED DESCRIPTION

A vast array of testing procedures with varying conditions along with their results are presented herein to illustrate these desirable member characteristics, achievable by the inventive composition, compounding techniques, additives, extrusion conditions, and other factors for producing both neat PLA formulations and PLA composite-based members for use as particularly window and door components. Tests were designed to explore various aspects, characteristics, and properties of interest for compositions and corresponding samples. Accordingly, the description below will be presented in sections with headings corresponding to the various tests.

### The Effects of Capping

Tests as detailed below show the effects of co-extruding a capping material onto the surface of extruded members made of PLA-wood composites as well as neat PLA formulations. As detailed below, the tests were designed to investigate the effects of capping on density, flexural modulus, tensile modulus, heat shrink, crystallization, heat distortion temperature, hydrolysis resistance and adhesion of various capping materials to PLA-wood composites as well as neat PLA formulations. The conditions and results of these tests are described below.

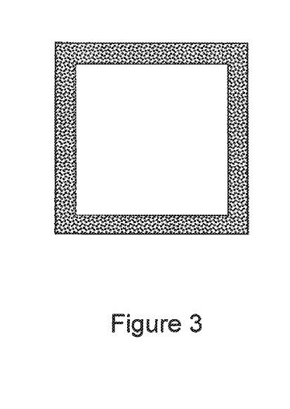

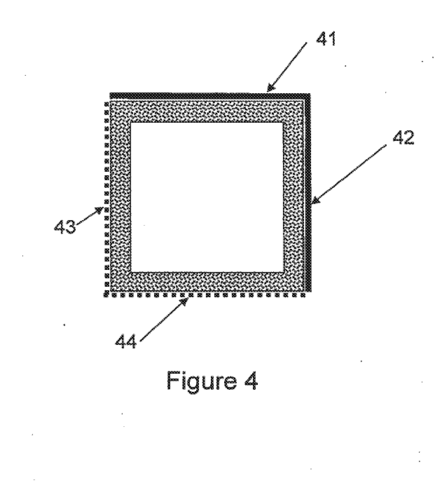

A composite comprising PLA and wood fiber for use as a base extrusion was prepared in pellet form according to the procedures set forth in detail below. The pellets were fed into a profile extruder, as detailed below, which produced the simple square extruded members shown in FIGS. 3 and 4. Extrusions were made with and without capping material co-extruded onto the surface of the PLA-wood composite base extrusions, and with capping materials of different compositions, as described in Sample Profiles 2-8 below. In addition, two extrusion runs were made with PLA, wood fiber, and a process aid fed directly into the extruder as described in Sample Profile 2, without going through a separate compounding and pelletizing step to test the viability of direct extrusion for PLA-wood composites. In Sample Profile 9, a capping material was coextruded onto the base extrusion, while in Sample Profile 10, no capping material was used. The extrusion conditions for the various sample profiles are shown in Table 5, and measured properties of the extruded members are shown in Table 7. The compositions of the various capping materials are shown in Tables 1-4. Specimens were taken from the resulting sample profiles and the following tests were conducted on the specimens and the results compiled.

The individual tests were conducted in the following manners.

Density

Density of the specimens was measured using an AccuPyc™ 1330 gas displacement pycnometer, available from Micromeritics Instrument Corporation, 4356 Communications Drive, Norcross, Ga., 30093-2901. The gas used was nitrogen. Specimens were obtained by cutting the side of the extruded rectangular sample profiles into strips 1″ wide×1″ tall. The specimen was weighed and then placed into the pycnometer for density measurement.

Flexural Modulus

Specimens were prepared by cutting 0.5″×3×0.09″ strips from the sides of the extruded rectangular sample profiles. Flexural modulus was tested according to ASTM D790-03 with simple beam supports spaced at a distance of 1.53 inches and the contact points having a radius of 0.043 inches. Force was applied using an Instron 5500R tensile tester. Flexural strength was calculated using the maximum value on the force versus displacement curve generated as outlined in ASTM D790-03.

Tensile Modulus

Specimens were prepared by cutting 0.5×6×0.09″ strips from the sides of the extruded rectangular sample profiles. The specimens were conditioned at standard ASTM conditions (21° Celsius (70° F.)/50% RH). Tensile modulus was tested using an Instron 5500R tensile tester, using a gauge length of 4.00 inches and a cross head speed of 0.200 inches per minute. The data was processed using Instron Series IX Automated Materials Testing System Version 5.25 software with Testing Module Rev. 1.16.

Heat Shrink

Specimens were prepared by cutting 12.0 inch long sections from the extruded rectangular sample profiles. The specimens were kept at room temperature for a sufficient time to assure equilibration. A first scribe mark and a second scribe mark were then made using a scribing tool having scribing styli spaced from each other at a fixed distance of 10.0 inches. The specimens were then placed on a flat surface in a forced air oven that had been preheated to 82.0° Celsius and that could maintain that temperature to within +30° Celsius. The specimens were left in the oven for 60 minutes. The specimens were then removed from the oven and allowed to cool to room temperature. One of the scribe styli was placed at the first original scribe mark, and a third scribe mark was made at the fixed distance of 10.0 inches. The distance between the original second scribe mark and the newly applied third scribe mark after heat treatment was measured. The distance, in inches, between the two scribe marks was divided by 10 to obtain the fractional shrinkage. The fractional shrinkage was multiplied by 100 to obtain percent shrink as a result of the heat exposure.

Capping Adhesion

Capping adhesion was measured according to ASTM D5179-02, wherein an aluminum stud or button having the dimensions prescribed therein was adhered to the capping material extruded onto the surface of PLA-wood composite base extrusions. After curing of the adhesive, the button was pulled from the extruded members using an Instron Model 4505 tensile tester equipped with a 1124 pound load cell. This instrument measured the force at the time of fracture between the capping material and the PLA wood composite base extrusion on which it was applied. Resulting data indicate the force required to remove the capping material from the underlying extruded PLA-wood composite using a ¾′ diameter button.

The nature of the break between the capping material and the underlying base extrusion was also noted. The break was reported as either adhesive or cohesive failure, depending upon whether the fracture interface occurred between the surface of the PLA-wood composite base extrusion and the capping material (adhesive failure) or whether portions of the PLA-wood composite base extrusion or the capping material fractured at locations other than at the interface between them (cohesive failure). In the latter case, portions of either the capping material or the PLA-wood composite adhered to the other surface after failure.

Compounding and Pelletizing of Composites Used to Extrude Sample Profiles

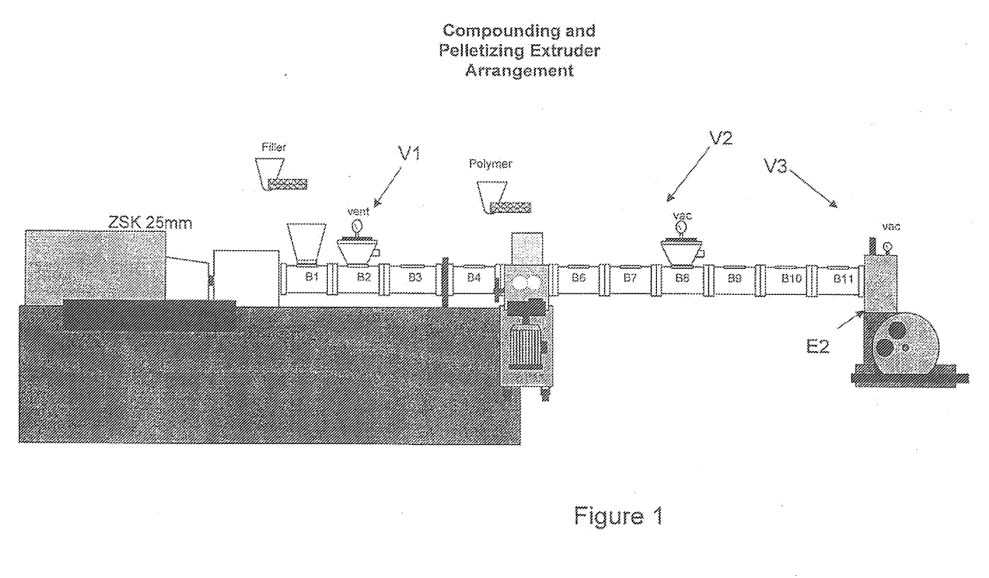

Preparation of wood fiber for incorporation into a polymer composite is described in some detail in U.S. Pat. No. 6,280,667 owned by the assignee of the present disclosure. This patent is hereby incorporated by reference in its entirety. Generally, for the tests described herein, wood fiber was classified first through a US Standard 30 mesh screen and then an 80 mesh screen, with the wood fiber that passed the 30 mesh screen but was retained in the 80 mesh screen being used in preparing the PLA-wood composite. Referring to FIG. 1, the wood fiber so obtained was fed into barrel section B1 of a ZSK 25 mm extruder running at 300 rpm and was heated to approximately 1500 Celsius as it passed into section B2, where water vapor was allowed to escape through vent V1. The heated and dried wood fiber was further heated and further dried in barrel sections B3 and B4. The wood fiber then passed into section B5, where NatureWorks PLA pellets obtained from NatureWorks LLC of Minnetonka, Minn., were added, using a gravimetric metering side feeder. The PLA pellets were added in an amount sufficient to produce the desired composite of PLA and wood fiber.

As used herein the term compounding will refer to the process of combining a polymeric material with at least one other ingredient, either polymeric or non-polymeric, at a temperature sufficiently elevated to allow the ingredients to be mixed into a molten mass. The composite was then heated in barrel sections B6 and B7 to about 1600 Celsius and devolatilized through vacuum vent V2 in section B8, resulting in a molten composite. The composite was further compounded at 170° Celsius in barrel sections B9-B11, from which it dropped into a second single screw extruder E2. Extruder E2 was equipped with vacuum vent V3 for further devolatization of the composite, and was operated with a barrel temperature of 170-175° Celsius and a screw speed of 38 rpm. The screw compressed the molten composite and fed it into a pelletizing die that operated at a die temperature of 195° Celsius. The pelletizing die produced small cylindrical pellets of PLA-wood composite having a density of about 1.29 gm/cc. These pellets, in turn, were fed to a production scale profile extruder as described below to extrude the various sample profiles from which specimens were taken for testing.

Extrusion of Sample Profile 1

The PLA-wood composite pellets, produced as described above where the PLA used was 4060D, an amorphous PLA made by NatureWorks LLC, and the pellets were fed into the extruder system shown in FIG. 2. Extruder 200 is a production scale Davis Standard GC8 61 mm conical twin screw extruder with gravimetric feeders 202 and 204 for feeding both primary materials and additive and/or capping materials to the extruder. The extruder was further equipped with a vacuum port or vent 206 for controlled devolatilization of (removal of moisture from) the molten material. Heating and other temperature adjustments and controls conventional to extrusion equipment were also components of the extruder. For Sample Profile 1, the PLA-wood composite pellets were fed into the extruder in a gravimetrically metered manner through one of the feeders 202, a technique known as metered feeding. Extruder temperature, also known as melt temperature, was adjusted by removing the vacuum connection from the devolatilization port and visually monitoring the rheology of the molten material as it passed the port.

It was discovered that adjusting the temperature until the composite pellets in the observed molten material were not completely fused at the location of the devolatilization port, giving the molten material a somewhat lumpy texture, yielded an extruded sample profile with better and more consistent properties. This observation is consistent with the extrusion process and apparatus disclosed in U.S. Pat. No. 6,129,873, wherein polymer is devolatized during, not after, fusion in an extruder, to avoid fusing in the presence of excessive quantities of water, which tends to cause hydrolysis.

With continued reference to FIG. 2, extrusion die 210 was made up of primary die body 212 and capping plate or coextrusion die 214, which could be used to coextrude an outer or capping layer onto the PLA-wood composite base extrusion. Coextrusion die 214 was fed by extruders 222 and 224, each of which applied capping material to two adjacent sides of the PLA-wood composite base extrusion. The coextruded capping material applied by extruders 222 and 224 can be the same or different. For example, in FIG. 4 adjacent sides 43 and 44 can be capped with a first material, and adjacent sides 41 and 42 can be capped with a second material. The option of coextruding a capping material or not coextruding a capping material was selected by turning coextruders 222 and 224 on or off as needed. For the extrusion of Sample Profile 1, extrusion dies 222 and 224 were both used to extrude capping material A, having the composition shown in Table 1, onto the PLA-wood composite base extrusion. The resulting profile was thus capped on all sides by the same material. As seen in Table 1, capping material A contains a relatively large amount of calcium carbonate.

Referring again to FIG. 2, the extrusion apparatus further comprised a conventional calibration die 230 for applying vacuum to size and maintain the desired final shape of the extruded member as the member began to cool. After calibration, the extruded member passed through cooling tank 240, aided by Greiner Cat Pul puller 250, which was a pair of sectioned belts of conventional design. Finally, the continuous extruded member was cut into 4 foot lengths by traveling cut-off saw 260, also of conventional design, wherein the saw traveled with the extrusion while sawing, to allow continuous operation of the extruder during sawing. Specimens from the resulting sample profiles were subjected to the various tests described above.

During the extrusion of Sample Profile 1, it was noted that as the molten material passed through primary die body 212, it produced a chattering effect, perhaps due to the molten material sticking to internal surfaces of the die. If so, resistance caused by the molten material sticking to the internal surfaces of the die would be expected to produce a dense material and the screws of the extruder would be expected to work harder to force the material through the die. To investigate, the density of the resulting profile was measured with the results being shown in Table 7. The theoretical density of a well compressed composite made up of 60 wt % PLA and 40 wt % wood fiber is in the range of 1.3 to 1.4 grams per cubic centimeter (gm/cc) The actual measured density, shown in Table 7, is about 1.3761 gm/cc. This indicates that the composite in Sample Profile 1 was well compressed by the extruder and relatively free of voids. It will also be noted from Table 5 that the current drawn by the extruder motor was relatively high while extruding Sample Profile 1 compared to other sample profiles. This too may be an indicator of good compression of the molten material since the motor current draw indicates a high motor torque required to compress and move the molten material through the extruder.

Extrusion of Sample Profile 2

To produce Sample Profile 2, PLA-wood composite pellets produced as described above were extruded in the same manner as for Sample Profile 1 and with capping material A applied to all sides of the PLA-wood composite base extrusion. For this run, however, a process aid in the form of a blend of paraffin wax, montan wax, and a glycerol ester of a fatty acid, commercially available as XL-623 from Amerilubes of Charlotte, N.C., was added in an amount of 0.6% by weight of the composite. The XL-623 was metered into the extruder using the second gravimetric feeder 204 of extruder 200. The addition of the XL-623 reduced the chattering effect at primary die body 212 to an insignificant level, while also reducing the current drawn by the extruder motor to 12.5 amperes for Sample Profile 2, a significant reduction from the draw of 74.0 amperes seen for Sample Profile 1. As shown in Table 7, the addition of the XL-623 also resulted in a reduction in the density of the Sample Profile 2 to 1.1361 gm/cc, which is well below the theoretical density of a well compressed 60% PLA and 40% wood fiber composite.

Extrusion of Sample Profile 3

To extrude Sample Profile 3, the extruder was operated in the same manner described immediately above, except that capping coextruders 222 and 224 were turned off. This produced an uncapped PLA-wood composite base extrusion. As seen in Table 7, this profile exhibited decreased density as well as decreased flexural and tensile moduli and increased heat shrink. This result suggests that the coextruded capping of the Sample Profiles 1 and 2 had an unexpected beneficial effect on mechanical properties as well as on density of the extruded members. Said another way, removing the capping appears to have resulted in diminished mechanical properties of the extruded members.

Extrusion of Sample Profiles 4-7 with Varied Capping Materials

Sample Profiles 4-7 were extruded in the same general manner as in Sample Profile 2 using the PLA-wood composite pellets produced as described, but with varying extrusion conditions and coextruded capping materials as shown in Table 5 and in Tables 1-4. Extrusion of Sample Profiles 4-7 illustrate, among other things, that a range of properties can be obtained by (1) using different capping materials; (2) using the same capping materials on all four sides of an extruded member; (3) using different capping materials on different sides of the extruded member; and (4) using a capping material on only two adjacent sides.

Adhesion of Capping Material B for Sample Profile 5 was tested according to ASTM D5179 and found to be low and variable, with the minimum adhesion being less than half of the average of samples taken along the 48″ length of the extruded-sample profile. Failure occurred at the adhesive interface, not in the PLA-wood composite base extrusion or in the capping layer. Adhesion for Capping Material D of Sample Profile 7 was quite high, with failure occurring in the PLA-wood composite base extrusion, rather than at the adhesive interface between the base extrusion and the capping layer. Adhesion of Capping Material A of Sample Profile 9 was found to be better than that of Capping Material B of Sample Profile 5, but failed at the adhesive interface and not in the PLA-wood composite base extrusion or capping layer.

Extrusion of Sample Profile 8

For Sample Profile 8, PLA 4060D pellets from NatureWorks LLC were mixed with Confluence brand firewood pellets in a ratio of about 60 wt PLA to about 40 wt % wood, and fed into extruder 200. Capping material A was coextruded onto the PLA-wood composite base extrusion. The mechanical properties of the resulting Sample Profile 8 are seen to be relatively poor compared to the other extruded sample profiles, as shown by the results in Table 7.

Direct Extrusion of Sample Profile 9

To produce Sample Profile 9, PLA 4060D pellets were mixed with wood fiber in a ratio of about 60 wt PLA to about 40 wt % wood fiber to form a blend and fed directly, without prior compounding and pelletization, into the extruder 200. Although these materials were mixed prior to being fed in to the extruder, they could also be fed individually and mixed within the extruder. Process aid XL-623 was also blended into the mixture in an amount of about 0.6 wt % of the final composite. The PLA-wood composite base extrusion was capped with coextruded capping material A on all sides. The gravimetric metering devices on extruder 200 were not used. Instead, the mix was allowed to feed at a rate determined by the extruder screws, a feed technique known as flood feeding. As shown in Table 7, the result was Sample Profile 9 which had relatively good mechanical properties compared to Sample Profiles 1-8. This may indicate that direct extrusion of the components of a PLA-wood composite so that they are mixed and compounded in the primary extruder itself is viable as well as when the components are compounded and pelletized in a separate process.

Direct Extrusion of Profile 10

To produce Sample Profile 10, the extrusion approach and PLA-wood composite formulation of Sample Profile 9 was used, but without coextruding any capping material onto the base extrusion. As seen in Table 7, the improved properties of the capped Sample Profile 9 over the uncapped Sample Profile 10 tends to indicate that the capping material produces improvements in mechanical properties, increased density, and reduced heat shrink.

The following tables summarize the details of the foregoing extrusions of Sample Profiles 1 through 10 and also present the results of the testing conducted on specimens taken from the sample profiles. PHR in these and all tables means parts per hundred resin, whereby the term resin refers to the polymer used in the formulation.

TABLE 1
Composition of Capping Material A

| | | WEIGHT |
|---|---|---|
| COMPONENT | PHR | FRACTION |
| PVC | 100 | 0.45558 |
| Calcium | 100 | 0.45558 |
| Carbonate | | |
| Oxidized | 1.5 | 0.00683 |
| Polyethylene | | |
| Calcium | 4 | 0.01822 |
| Stearate | | |
| Paraffin Wax | 3.5 | 0.01595 |
| Heat Stabilizer | 10 | 0.04556 |
| Pigment | 0.5 | 0.00228 |

TABLE 2
Composition of Capping Material B

| | | WEIGHT |
|---|---|---|
| COMPONENT | PHR | FRACTION |
| PVC | 100 | 0.7698229 |
| Heat Stabilizer | 3.0 | 0.0230947 |
| Acrylic Modifier | 7.0 | 0.0538876 |
| Lubricants | 2.2 | 0.0169361 |
| Oxidized | 0.4 | 0.0030793 |
| Polyethylene | | |
| UV Absorber | 7.0 | 0.0538876 |
| Light Stabilizer | 0.3 | 0.0023095 |
| Pigment | 10 | 0.0769823 |

TABLE 3
Composition of Capping Material C

| | | WEIGHT |
|---|---|---|
| COMPONENT | PHR | FRACTION |
| PVC | 100 | 0.78666 |
| Titanium | 15 | 0.118 |
| Dioxide | | |
| Acrylic Modifier | 2 | 0.05113 |
| Calcium Stearate | 1.5 | 0.0118 |
| Bead Wax | 2 | 0.01573 |
| Heat Stabilizer | 1.5 | 0.0118 |
| Pigment | 0.62 | 0.00488 |

TABLE 4
Composition of Capping Material D

| | | WEIGHT |
|---|---|---|
| COMPONENT | PHR | FRACTION |
| Polymethyl | 100 | 0.9 |
| Methacrylate | | |
| Pigment | 11.1 | 0.1 |

TABLE 5
Summary of Run Conditions And Resulting Extruder Current Draw

| SAM- | | | | | | |
|---|---|---|---|---|---|---|
| PLE | | | | | | |
| PRO- | INPUT | ADDI- | CAP | CAP | FEED | CURRENT |
| FILE | MATERIAL | TIVE | 1 | 2 | METHOD | AMPERES |
| 1 | Pellets | None | A | A | Metered | 74.0 |
| 2 | Pellets | XL-623 | A | A | Metered | 12.5 |
| 3 | Pellets | XL-623 | None | None | Metered | 14.2 |
| 4 | Pellets | XL-623 | B | None | Metered | 12.2 |
| 5 | Pellets | XL-623 | B | C | Metered | 12.2 |
| 6 | Pellets | XL-623 | C | D | Metered | 12.2 |
| 7 | Pellets | XL-623 | D | D | Metered | 12.4 |
| 8 | PLA + | XL-623 | A | A | Metered | 27.5 |
| | Firewood | | | | | |
| | Pellets | | | | | |
| 9 | Raw Blend | XL-623 | A | A | Flood | 38.1 |
| 10 | Raw Blend | XL-623 | None | None | Flood | 38.1 |

TABLE 6
Capping Thickness

| | CAPPING |
|---|---|
| SAMPLE | THICKNESS |
| PROFILE | inches |
| 1 | 0.012 |
| 2 | 0.010 |
| 3 | 0 |
| 4 | 0.012 |
| 5 | 0.015 |
| 6 | 0.014 |
| 7 | 0.015 |
| 8 | 0.015 |
| 9 | 0.015 |
| 10 | 0 |

TABLE 7
Summary of Testing Results

| | | FLEXURAL | TENSILE | |
|---|---|---|---|---|
| SAMPLE | DENSITY | MODULUS | MODULUS | SHRINK |
| PROFILE | (gm/cc) | (ksi) | (ksi) | % |
| 1 | 1.3761 | 466 | 855.3 | 1.2 |
| 2 | 1.1361 | 518.6 | 845.9 | 1.0 |
| 3 | 1.1151 | 364.5 | 707.1 | 2.2 |
| 4 | 1.1249 | 475 | 792 | 1.4 |
| 5 | 1.1474 | 492 | 782 | 1.3 |
| 6 | 1.1382 | 508 | 783 | 0.9 |
| 7 | 1.1574 | 501 | 793 | 0.75 |
| 8 | 1.1805 | 246 | 575 | 1.95 |
| 9 | .1872 | 548 | 924 | 0.8 |
| 10 | 1.0872 | 437 | 934.3 | 1.05 |

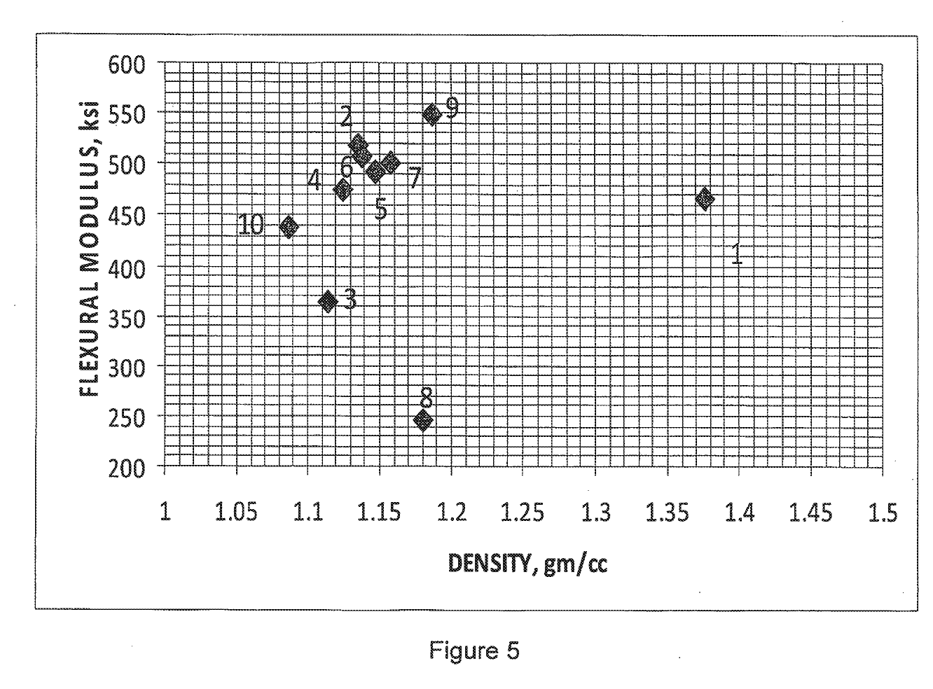

The extruded members illustrated in FIGS. 3 and 4 may be used, for example, as vertical members, or balusters, in stair and porch railings, as well as in picket fences and the like. In such applications, similar to the needs of window and door components, lateral or bending loads are the primary loads borne by the profiles during use. As a result, flexural modulus is an important mechanical property for the sample profiles above. Table 7 shows test results of flexural modulus, density, and other measurements performed on the various sample profiles extruded as described above. FIG. 5 is a graph of the flexural modulus results taken from Table 7, plotted against density, also taken from Table 7. Reference numbers on the graph refer to the sample profile numbers from Tables 5, 6 and 7. Referring to Sample Profiles 2 and 3, which represent the same run conditions, with the exception that Sample Profile 2 is capped and Sample Profile 3 is uncapped, it is seen that capping alone increases the flexural modulus of the resulting sample profile by a factor of 1.42, or 42%. Similarly, comparing Sample Profiles 9 and 10, it is seen that capping increases flexural modulus by about 25% under conditions where the components of the composite are direct or flood fed into the extruder. It is concluded therefore that capping a PLA-wood composite base extrusion significantly enhances the flexural modulus of the resulting member.

FIG. 5 illustrates that capping tends to increase the density of an extruded sample profile. In particular, Sample Profiles 3 and 10 with no capping applied have the lowest density, while Sample Profile 4, which is capped on only two adjacent sides, has a slightly higher density, though not as high as the fully capped Sample Profiles 1 and 9. There also is a generally positive relationship between density and flexural modulus for the sample profiles extruded from the PLA-wood composite pellets as opposed to those produced by direct or flood fed extrusion which did not undergo compounding or pelletizing in a separate process. An exception to this may be Sample Profile 1, which tends to show that the absence of the XL-623 process aid appears to increase density without a commensurate increase in flexural modulus.

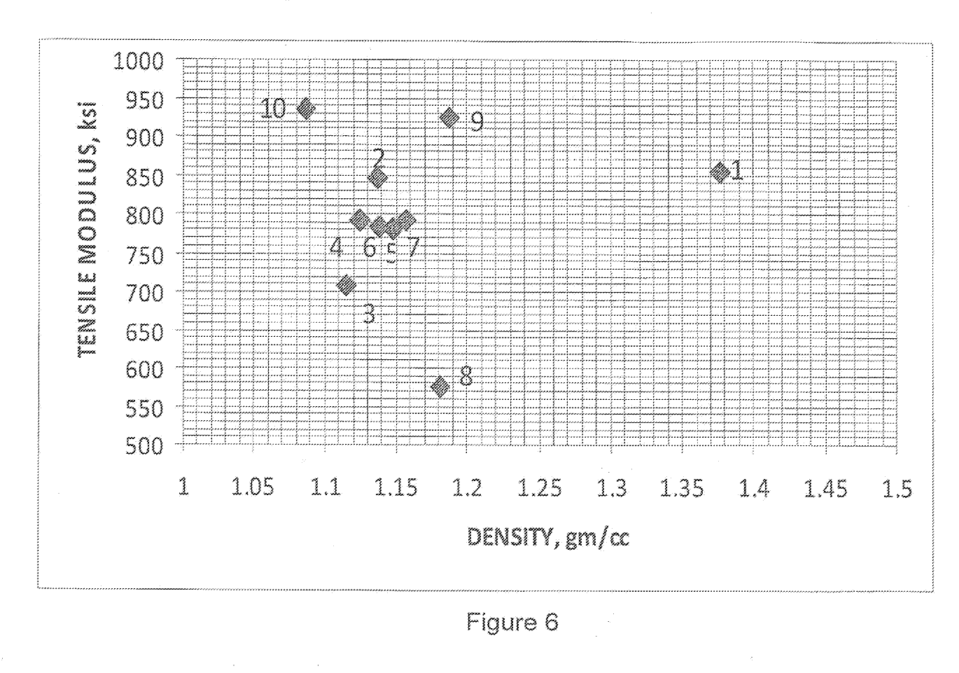

Capping of a PLA-wood composite base extrusion did not affect tensile modulus. Referring to FIG. 6, which graphs tensile modulus against density, capping appears to increase tensile modulus for Sample Profiles 2 and 3, but not for Sample Profiles 9 and 10. As illustrated by Sample Profiles 4-7, is shown that the particular choice of capping material has little or no effect on tensile modulus, even though it is shown to have some effect on density. Thus, coextruding a capping material onto a PLA-wood composite base extrusion provides no particular advantage where the resulting profile is to be exposed primarily to tensile forces.

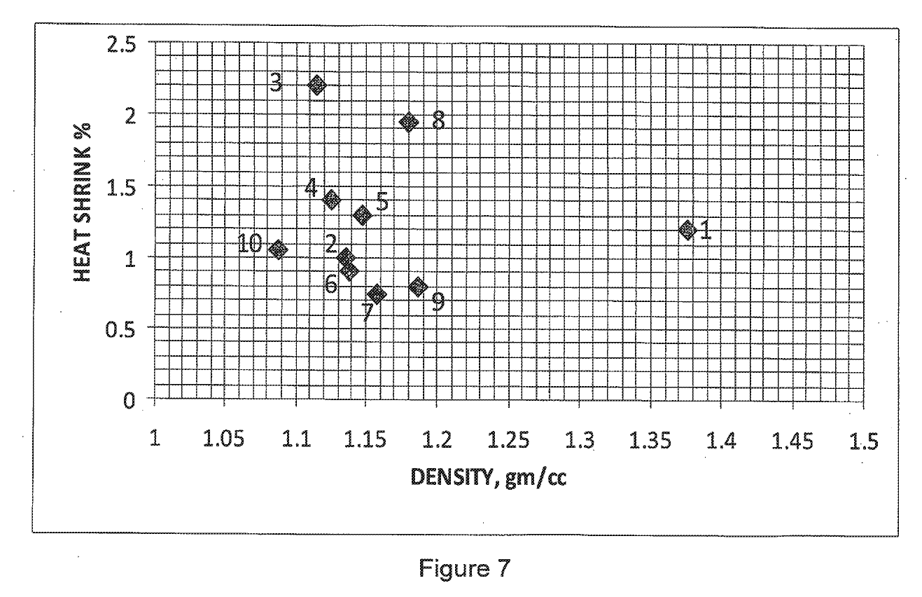

Referring to FIG. 7, which graphs percent heat shrink versus density, it is shown, in comparing Sample Profile 2 with Sample Profile 3, and Sample Profile 9 with Sample Profile 10, that capping tends to reduce heat shrink. Moreover, it is shown that by increasing density heat shrink is reduced, although the scatter in the data in FIG. 7 would indicate that other factors also may contribute to heat shrink. It is concluded that applying a capping material to a PEA-wood composite base extrusion reduces heat shrink of the extrusion when exposed to relatively high temperatures.

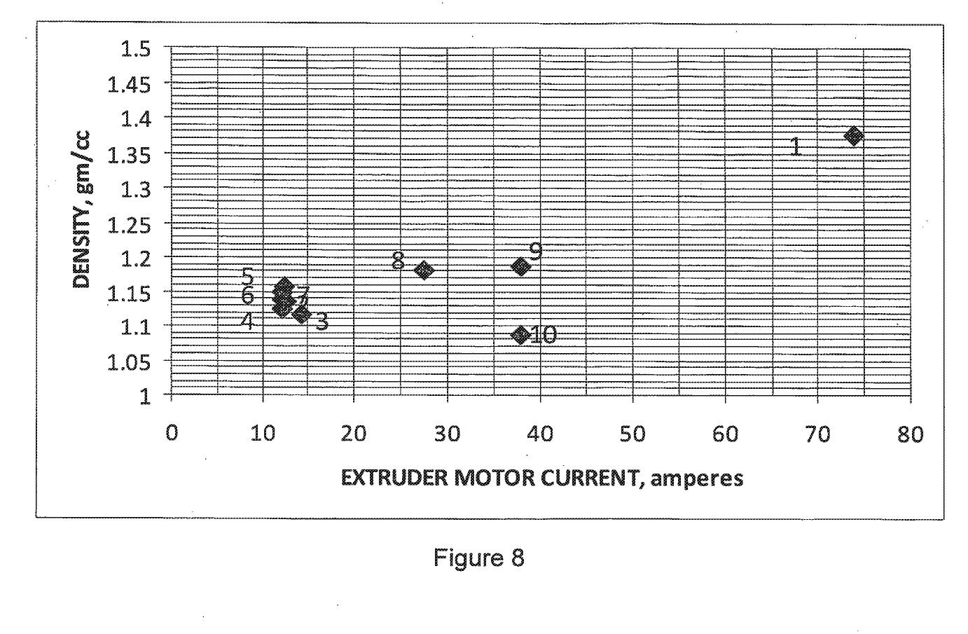

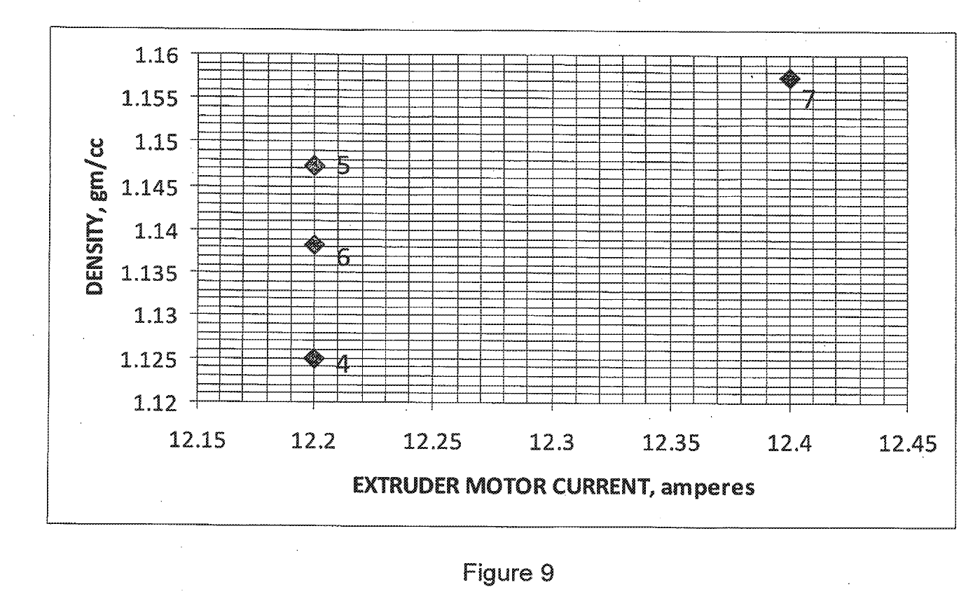

Increased density of an extruded sample improves mechanical properties and decreases heat shrink of the sample profile. Accordingly, factors contributing to or indicating increased density are presented. One such factor is the current drawn by the motor driving the extruder screws during extrusion. This, in turn, is a measure of the torque that the extruder screw requires, and indicates the level of compression the extruder applies to the molten material. As shown in FIG. 8, which graphs density against extruder motor current, density generally increases with increased motor current for sample profiles extruded using metered flow of pellets to the extruder. Sample Profiles 9 and 10, which were extruded using unmetered or flood feeding, do not fit this pattern, since capping produces an increase in density without an increase in motor current. However, it should also be noted that the motor current for Sample Profiles 9 and 10 is higher than the previous samples where profiles were extruded using metered flow of composite pellets. FIG. 9 shows the data of FIG. 8, with the density scale expanded.

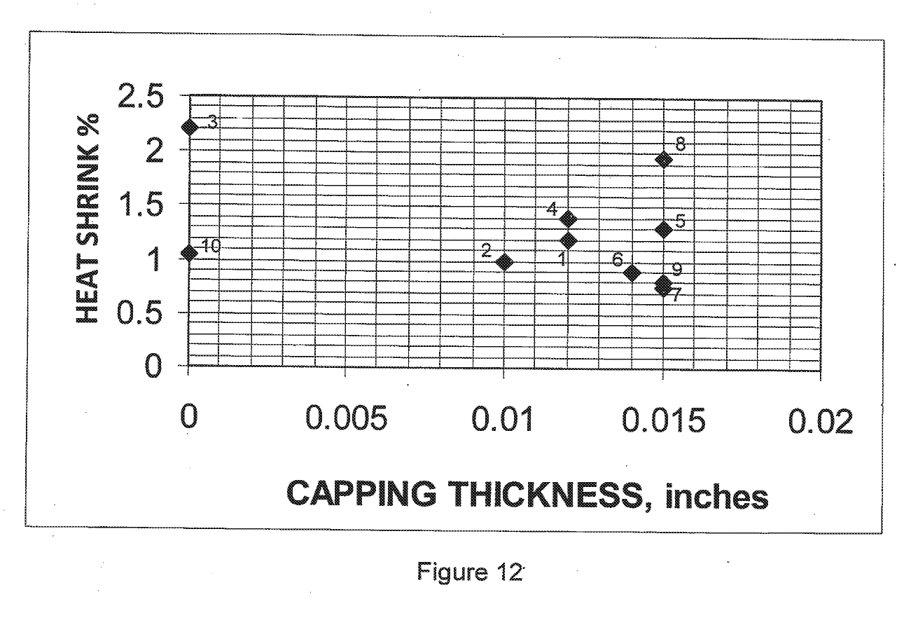

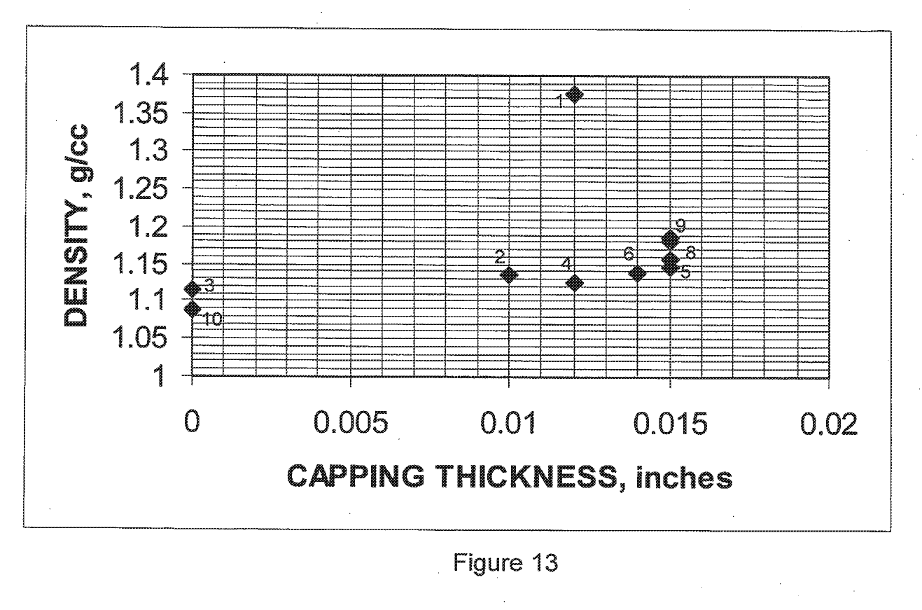

The thickness of the various capping layers of Sample Profiles 1-10 was also measured, with the results shown in Table 6. Even though the same extrusion dies were used for all of the extrusion runs producing these samples, there was enough variation in capping layer thickness to show a positive trend in flexural modulus with increased capping layer thickness. As seen in FIGS. 11 and 12, however, a correlation between capping layer thickness and tensile modulus and on heat shrink is not observed. Similarly, as seen in FIG. 13, capping layer thickness does not effect density.

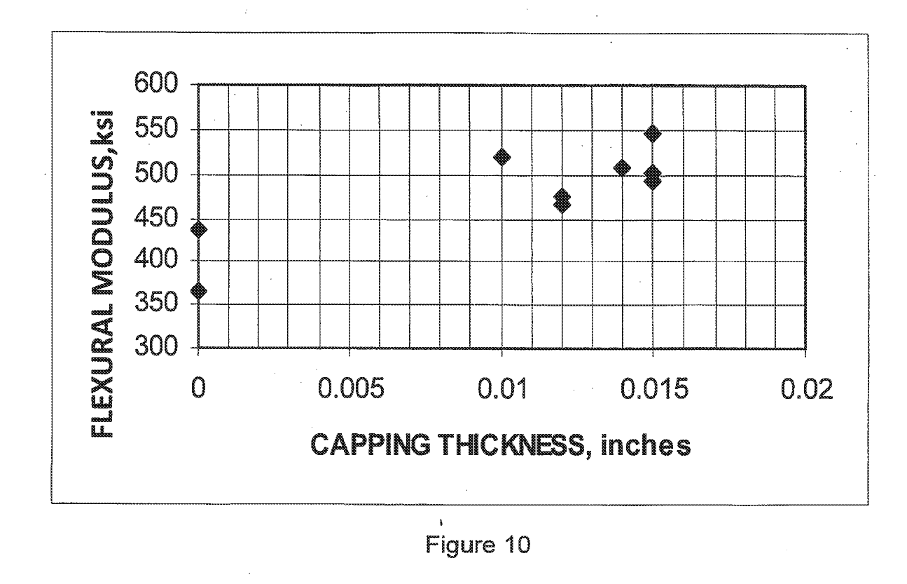

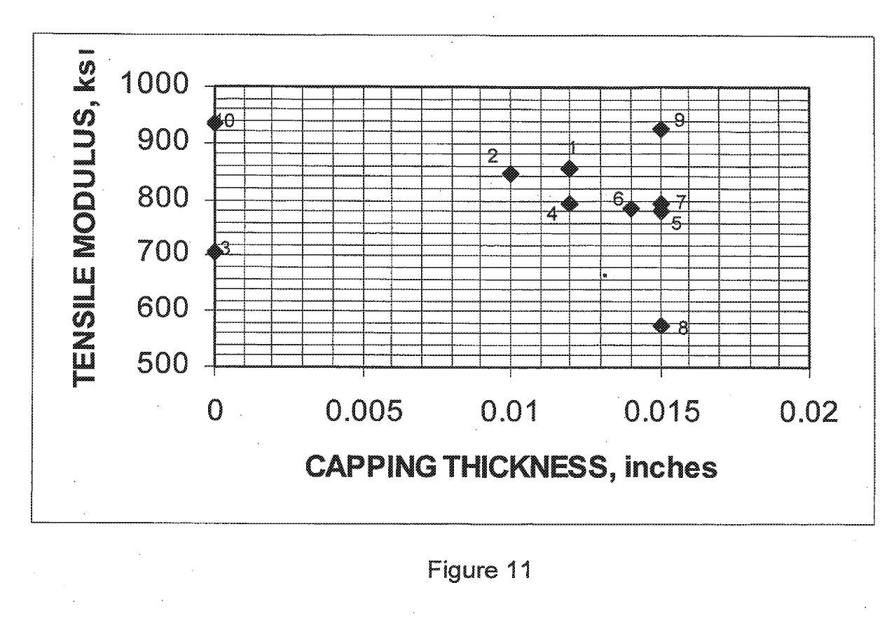

While the inventors do not wish to be bound by any particular theory as to the specific mechanisms that enable capping layers to improve the properties of PLA-wood composite base extrusions, some possible explanations are suggested by the data shown in FIGS. 5-13. First, comparison of Sample Profiles 2 and 3, and Sample Profiles 9 and 10 indicate that capping increases density. That may make the extruded member less compressible, which tends to increase flexural modulus, but may produce less of an effect on tensile modulus.

### Improving Heat Distortion Temperature

The inherent heat distortion temperature (HDT) of PLA is generally too low for use in hot environments or in direct sunlight. These are, of course, the very environments within which window and door components and other building product members must perform. The inventors conducted testing in an effort to determine whether the HUT of a PLA composition can be raised to a value that makes the corresponding member viable for use when exposed to the environment for long periods of time. Such testing and results thereof are discussed below.

In a first series of tests, samples were extruded with a laboratory extruder with various run conditions and compositions. Various formulations of a PLA-wood composite, shown as Samples 1-5 in Table 8 below, were compounded and pelletized as described above and extruded to form substantially flat samples using a Brabender laboratory extruder. The formulation shown as Sample 6 in Table 8 was extruded in a production scale twin screw extruder into a rectangular sample profile. Specimens were taken from the resulting samples and subjected to testing to determine their heat distortion temperatures. The experimental formulations were prepared by mixing the PLA, wood fiber, and various additives in the compounding extruder and pelletizing the resulting blends as detailed above for extrusion in the subsequent profile extrusion operation.

TABLE 8
Sample Formulations of PLA-Wood Composites
For Heat Distortion Temperature Testing

| | PLA | WOOD | | LAK- | XL- | CALCIUM |
|---|---|---|---|---|---|---|
| SAM- | 4032D | FIBER | TALC | 301 | 623 | STEARATE |
| PLE | % | % | % | % | % | % |
| 1 | 60 | 40 | 0 | 0 | 0 | 0 |
| 2 | 59.1 | 39.4 | 1.0 | 0.5 | 0 | 0 |
| 3 | 58.8 | 39.2 | 1.0 | 1.0 | 0 | 0 |
| 4 | 59.4 | 39.6 | 1.0 | 0 | 0 | 0 |
| 5 | 59.4 | 39.6 | 0 | 1.0 | 0 | 0 |
| 6 | 55 | 40 | 1.0 | 1.0 | 2.0 | 1.0 |

In Table 8, PLA 4032D is a substantially homopolymeric polylactic acid obtained from NatureWorks LLC, of Minnetonka, Minn. It is preferred that the PLA be substantially homopolymeric so as to promote crystallization. It will be appreciated that since lactic acid is a chiral compound. PLA can exist either as PLA-L or PLA-D. As used herein, the term homopolymeric PLA will refer to either PLA-L or PLA-D, wherein the monomeric units making up each polymer are all of substantially the same chirality, either L or D. It will also be appreciated that in some instances, PLA-L and PLA-D will, when combined, co-crystallize to form stereoisomers, provided that the PLA-L and PLA-D are each substantially homopolymeric, and that, as used herein, PLA containing such stereoisomers is also to be considered homopolymeric.

It was found that nucleating agents can play a significant role in improving the speed and degree of polymer crystallization. Nucleating agents can be either organic or inorganic, and specific nucleating agents are more suitable than others for particular polymers. Talc, in the form of a finely ground powder, has been found to be a particularly suitable inorganic nucleating agent for PLA. Suitable organic nucleating agents for polyesters include metal salts of aromatic sulphonates, as disclosed in published U.S. Patent application 2007/0270535A1, incorporated herein by reference. One particularly useful salt of an aromatic sulphonate is LAK-301, which is commercially available from Takemoto Oil and Fat Co, LTD, of Japan. It is believed that there may be advantages to using a combination of organic and inorganic nucleating agents to achieve optimal crystallization.

XL-623 is a process aid that acts as a metal release agent and possible stabilizer. Calcium stearate is a process aid that acts as a lubricant and is used in the processing of polymeric materials.

Wood fiber was prepared as described above and mixed with PLA. Depending on the formulation being prepared, talc, LAK 301, and the other ingredients were added to the mixture in the amounts shown in Table 8. The combined blend was then compounded and pelletized in the manner detailed above to produce pellets for use in extruding samples for testing.

For the HDT testing of Samples 1-5 in Table 8, the PLA-wood composite pellets for each sample were fed into a Brabender single screw extruder using a die that produced a generally flat extruded member having a thickness of 0.090 inches to 0.100 inches and a width of about 1.0 inch. The extruded member was deposited onto a moving belt with a speed adjusted to match the extrusion speed and cooled as the belt carried the material away from the extruder. Three different cooling rates of the extruded member on the belt were used, along with different initial melt temperatures within the extruder. Cooling temperature profiles were determined by extruding a neat PLA formulation and embedding a thermocouple in the extruded member as it exited the die. The thermocouple traveled with the extruded member to the end of the cooling belt while sending temperature data to a data logger, thereby producing time-temperature profiles for each cooling rate. Initial melt temperatures were measured using a thermocouple located in the die.

The different cooling rates produced samples with surprisingly different material properties, including different heat distortion temperatures. This was due at least in part, it is believed, to differences in the amount of crystallization occurring during the cooling process. Early onset of nucleation of PLA crystals influenced by lower melt temperatures also is a contributing factor. Because crystallization of the PLA is a significant factor in determining the HDT of each extruded sample, and because the temperature range of 100° Celsius to 120° Celsius is a particularly significant range in the crystallization behavior of PLA, each of the time-temperature profiles corresponding to the cooling rates was characterized by the time the extruded sample spent in that temperature range. The three cooling rates, and the resulting times within the critical range were:

Slow cooling rate—heat lamps were placed over the belt allowing the sample's time spent in the temperature range of 100° Celsius to 120° Celsius to be in the range of 50 seconds to 275 seconds as measured by the thermocouple.

Medium cooling rate—cooling of the sample was with room temperature air (about 21° Celsius), with no added heat, allowing the sample's time spent in the temperature range of 100° Celsius to 120° Celsius to be in the range of 30 seconds to 40 seconds as measured by the thermocouple.

Fast cooling rate—either compressed air was blown on the sample immediately upon exiting the die or the sample was immersed in water at a temperature of about 10° Celsius (50° Fahrenheit) in the cooling tank. In either case the cooling method allowed the sample's time spent in the range of 100° Celsius to 120° Celsius to be in the range of less than 15 seconds as measured by the thermocouple.

Beyond the cooling methods described above, crystallization can be further enhanced by a process commonly called cold crystallization. In cases where it is desired to achieve additional crystallization, cold crystallization refers to taking a member that has fully cooled, reheating it and holding it at a somewhat elevated temperature, that is below its melt temperature, for a longer period of time than might be available in other processes, such as extrusion. The temperature and time can be selected to achieve the desired level of crystallization. A cold crystallization temperature range that has been found useful for PLA-wood composites is 100° C. to 120° C., however temperatures above or below this range can also increase crystallinity depending on composition of the member.

Specimens for heat distortion testing were obtained by cutting the resulting samples into pieces having a length of approximately 6 inches and a width of about 0.52 inches. The specimens were extracted from approximately the center of the extruded sheet to avoid any irregularities at the edges.

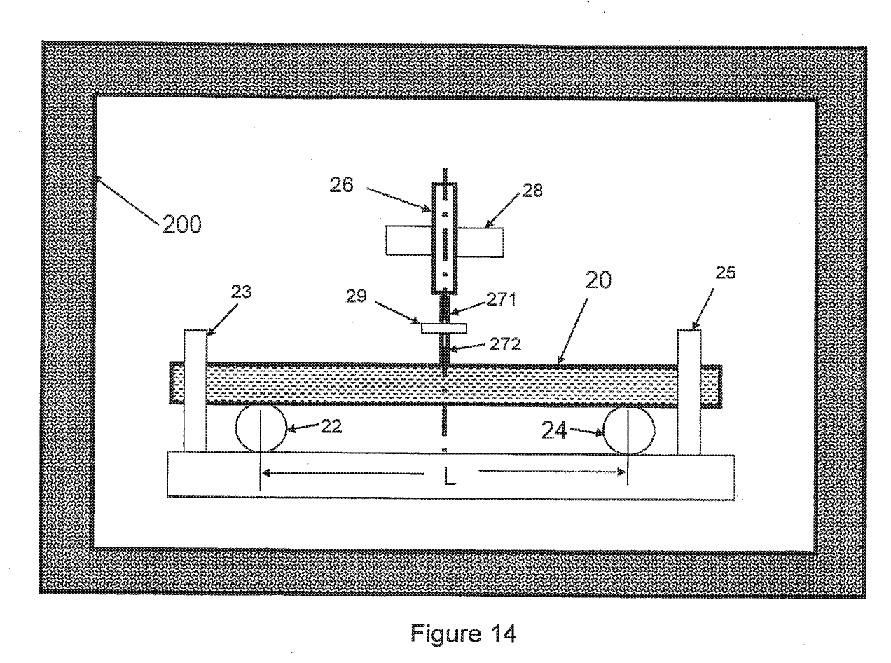

Heat distortion temperature was measured using the test fixture shown in FIG. 14. Specimens were placed edgewise in the test fixture, with the 0.52 inch dimension extending in the vertical direction. More specifically, each specimen 20 was placed on cylindrical supports 22 and 24, which were located a distance L apart. L was chosen to be 4.0 inches for the tests disclosed herein and the specimens 20 were held in an edgewise vertical orientation by pairs of vertical shafts 23 and 25. The shafts in each pair were spaced at a distance slightly greater than the thickness of the sample to hold specimen 20 in a stable vertical position without gripping it in a way that would cause measurement errors.

A deflection force of 500 grams was applied to each specimen 20 at a point midway between cylindrical supports 22 and 24. The deflection force was applied by a BEI 9600 spring loaded position sensor 21 having a position sensing shaft 271. Movement of shaft 271 in the vertical direction, in or out of sensor 26, induces a change in resistance that is measured and calibrated to indicate distance moved. Shaft 271 pressed against a second shaft 272 held in place by bracket 29. Shaft 272 then contacted specimen 20, thereby applying a deflection force to the specimen. The 500 gram force was therefore the sum of the spring force from sensor 26 and the weight of shaft 272. Calibration of the apparatus to produce a precise value of 500 grams was achieved by replacing specimen 20 with a balance to measure precisely 500 grams and adjusting the position of sensor 26 relative to bracket 28 until a force of 500 grams was obtained. After calibration, the test fixture, along with specimens 20, was placed in oven 200 and gradually heated until the specimens 20 softened sufficiently to deflect 0.1 inches, as measured by sensor 26, under the 500 gram load applied by sensor 26 and shaft 272. The oven temperature was measured using a thermocouple embedded in a second specimen having substantially the same dimensions as specimen 20 and placed proximate to each specimen 20 in oven 200. Heating of oven 200 to the heat deflection temperature of the specimens generally occurred over a period of about one hour. In order to avoid damage to sensor 26, the oven temperature was limited to 130° Celsius. For some specimens, the heat deflection temperature was found to be somewhat greater than 130° Celsius. In these cases, projected values of heat distortion temperature were calculated by linear extrapolation of deflection as a function of oven temperature in the region just below an oven temperature of 130° C. The sample compositions, extrusion conditions, and results of tests on a range of specimens taken from the extruded members described above are shown in Table 9.

TABLE 9
Sample Compositions and Extrusion Conditions and Heat
Distortion Temperature Measurements Laboratory Extruder

| | MELT | COOLING | LAK-301 | TALC | |
|---|---|---|---|---|---|
| SAMPLE | TEMP. ° C. | MODE | % | % | HDT ° C. |
| 7 | 170 | Fast | 0 | 1 | 53 |
| 8 | 165 | Fast | 0.5 | 1 | 55 |
| 9 | 160 | Medium | 0 | 0 | 57 |
| 10 | 170 | Medium | 0 | 0 | 57 |
| 11 | 160 | Fast | 0 | 1 | 65 |
| 12 | 185 | Fast | 1.0 | 1 | 78 |
| 13 | 180 | Fast | 1.0 | 0 | 103 |
| 14 | 170 | Medium | 0 | 1 | 117 |
| 15 | 160 | Medium | 0 | 1 | 117 |
| 16 | 175 | Fast | 1.0 | 0 | 120 |
| 17 | 180 | Fast | 1.0 | 1 | 121 |
| 18 | 165 | Medium | 0.5 | 1 | 126 |
| 19 | 170 | Fast | 1 | 1 | 132 |
| 20 | 170 | Medium | 1 | 1 | 137 |
| 21 | 160 | Fast | 1 | 1 | 142 |
| 22 | 160 | Medium | 1 | 1 | 146 |

Referring to Table 9, samples in the table were formulated with various combinations of nucleating agents, in particular LAK-301 and talc, extruded at various melt temperatures, and cooled either with air cooling (medium cooling rate) or water cooling (fast cooling rate). The slow cooling rate using heat lamps was also used, but it was felt that this cooling method might have limited value in a manufacturing setting, and for this reason samples using the slow cooling rate were not tested for heat distortion temperature. Melt temperature was measured in the extrusion die of the Brabender laboratory extruder by a thermocouple. It is noteworthy that the range in measured heat distortion temperature (HDT) of 53° Celsius to 146° Celsius is surprisingly large, considering the relatively small changes in extrusion and cooling conditions and in the nucleating agents used. The differences produced by fast cooling and medium cooling rates are quite large, but the mode of cooling does not strongly correlate with any particular pattern of HDT. For example, comparing Samples 21 and 22, both fast and medium cooling rates produce good values of HDT, while comparison of Samples 12 and 13 shows a large jump in HDT, even though a fast cooling rate was used for both samples.

The improvements in HDT exhibited by some of the samples, particularly the sudden jump in HDT between Samples 12 and 13 is due, at least in part, to a higher degree and earlier nucleation of PLA crystals in the extrusion phase followed by further crystallization of the PLA during the cooling phase. In particular, Samples 19-22, which exhibit the highest I-HDT values, all contain talc and LAK-301 nucleating agents, while no sample without a nucleating agent exhibits an HDT value above 57° Celsius. In addition, HDT is affected by melt temperature. This is also consistent with an enhanced nucleation of a crystalline polymer and further crystallization theory. Crystallization proceeds first by a nucleation phase (referred to herein as “nucleation” or “nucleation of PLA crystals”), which can only begin when the temperature reaches a certain relatively higher range, followed by a crystal growth stage (referred to herein as “crystallization” or “further crystallization”) that occurs at a relatively lower temperature range.

In light of the relatively low melt temperature in Samples 21 and 22, which exhibit the highest HDT values, it is suspected that such melt temperatures promote early and more complete nucleation of PLA crystals, perhaps even prior to the material exiting the extrusion die. Thus, the nucleation phase is extended to a longer time period. This accounts for the surprising result that the conditions of the extrusion and cooling processes can be selected to produce significant increases in HDT, even though the extruded member is in the crystallization temperature range during cooling for a relatively short time. Put another way, early initiation of nucleation of PLA crystals, even in the extruder, followed by a longer nucleation period, produces more nucleation sites and thereby reduces the need for longer crystal growth times to achieve adequate levels of crystallinity. For example, the material in Sample 21 spent less than 15 seconds in the temperature range of 100° Celsius to 120° Celsius (the range in which most crystal growth takes place), yet exhibited a HDT value of 142° C., a value that would be expected in a well crystallized polymer undergoing a longer period of crystal growth.

The formulation of Sample 6 in Table 8 was selected based upon the results from Samples 1-5 (extruded in the laboratory extruder). The formulation was pelletized as described above and extruded using the production scale Davis Standard GC8 61 mm conical twin screw extruder to investigate the scaling of the HDT phenomena noted from the laboratory extruder tests of Samples 1-5. Rectangular extrusion members were produced using various calibration die cooling techniques and various final cooling techniques. PLA-wood composite pellets were fed into the extruder in a gravimetrically metered manner. Extruder temperature was adjusted by removing the vacuum connection from the devolatilization port and visually monitoring the molten material as it passed the port. The melt temperature was adjusted until the pellets were not completely fused at the devolatilization port, but rather appeared to have a somewhat lumpy texture.

Extruded members using the formulation of Sample 6 were also produced with and without a capping layer to investigate the effects of capping on the HDT of completed extrusions. The composition of the capping layer material is shown in Table 10 below.

TABLE 10
Composition of Capping Material

| | | WEIGHT |
|---|---|---|
| COMPONENT | PHR | FRACTION |
| Polymethyl | 100 | 0.9 |
| Methacrylate | | |
| Pigment | 11.1 | 0.1 |

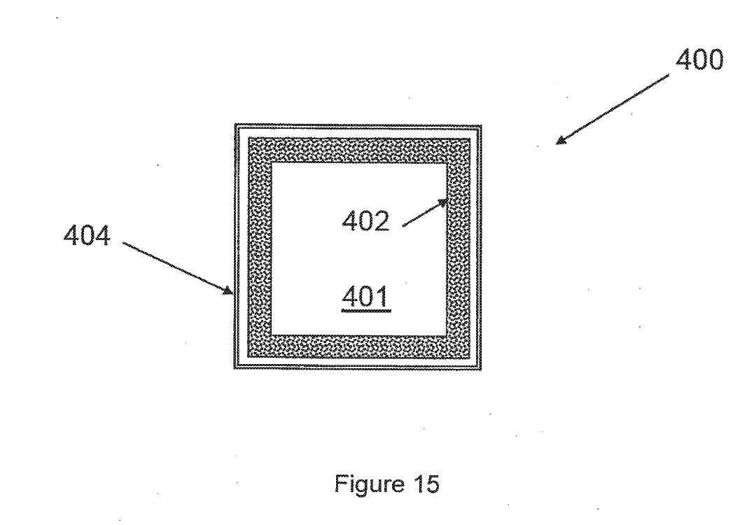

The basic cross-section of the capped members produced is illustrated in FIG. 15. FIG. 15 depicts a capped hollow extruded member 400 which includes a hollow space 401 defined by base extrusion layer 402, wherein all four sides were capped with the same capping material 404. Uncapped extrusions were extruded by turning off coextruders 222 and 224 (FIG. 2).

As detailed above, the extruder included a calibration die 230 for providing the final shape to the extruded member by applying a vacuum to the outside of the moving extrusion. The body of the calibration die had internal cooling channels through which water was circulated for primary cooling of the calibration die itself. Optionally, secondary cooling could be provided by cooling water circulating over and around the extruded member as it moved through the calibration die. Some of the samples for these tests were extruded with secondary cooling and some were extruded without secondary cooling.

A final cooling tank 240, which could be filled with water for faster cooling (water cooling) or not filled for slower cooling (air cooling), was disposed downstream of the calibration die. After exiting the calibration die, the extruded member passed through the final cooling tank 240. If the final cooling tank was filled with water, the final cooling stage was designated as water cooling, while if the final cooling tank was not filled with water, the final cooling stage was designated as air cooling. An additional mode was also used for some of the extruded members wherein the extruded member moved first through a shortened water cooling phase followed by an air cooling phase. This mode was designated as water and air cooling.

A self-contained temperature logging device was inserted into the hollow of a capped extruded member and located at various locations downstream of calibration die 230. The logging device was maintained in position by a magnet on the outside of the moving extruded member and was allowed to travel downstream with the extruded member for about two minutes, during which time the temperature of the interior of the extruded member was continuously measured and logged. For air cooling, the logged temperature data showed that the total time during which the extrusion temperature was above 100° Celsius but below 120° Celsius (the crystallization temperature range) was approximately 20 seconds. Temperature measurements were not taken for the water or for the water and air cooling modes. Finally, the extruded samples were cut into 4 foot lengths by traveling saw 260 and specimens were taken from the samples for HUT testing in the manner detailed above. The results of the HDT testing are presented in Table 11 below.

TABLE 11
Heat Distortion Temperature Results Production
Scale Extruder - Sample Formulation 6

| | SECONDARY | | | |
|---|---|---|---|---|
| | CALIBRATION | FINAL | CAPPING | |
| SAMPLE | COOLING | COOLING | LAYER | HDT, ° C. |
| 23 | Yes | Water | No | 49 |
| 24 | Yes | Water | Yes | 58 |
| 25 | Yes | Water and Air | No | 67 |
| 26 | Yes | Water and Air | Yes | 83 |
| 27 | Yes | Air | Yes | 115 |
| 28 | Yes | Air | No | 115 |
| 29 | No | Air | No | 120 |
| 30 | No | Air | Yes | 135 |

Comparing Sample 23 with Sample 24, Sample 25 with Sample 26, and Sample 29 with Sample 30, co-extruding a capping layer over the PLA-wood composite base extrusion improves HDT from between about 12% and about 23%. However, this did not occur when comparing Samples 27 and 28. Capping layers provide insulation to promote a slower cooling gradient, extended times in the crystallization temperature range, and thus more complete crystallization. Moreover, if the capping layer is coextruded at a higher temperature than the PLA-wood composite base extrusion, the capping material acts as a heat source to prolong higher temperatures in the PLA-wood composite to maintain it within the crystallization temperature range for longer periods of time, thereby again promoting more complete crystallinity.

The HDT test results indicate that the highest HDT of 135° Celsius is obtained with no secondary cooling in the calibration stage and air cooling in the final cooling stage, especially when a capping layer is applied. This is consistent with the observation that early initiation of nucleation of the PLA crystals as the material is extruded followed by longer times in the crystallization temperature range as it is cooled increases the completeness of crystallization within the polymer, thus increasing HDT. Compositions with HDT values above about 80° Celsius, and particularly above about 100° Celsius are believed to be commercially viable for use as members such as window and door components that are to be exposed to the elements for extended periods of time

### Improving Hydrolysis Resistance

Hydrolysis is a chemical reaction in which water reacts with a chemical compound to produce other chemical compounds. It typically involves the splitting of a bond within the chemical compound and the addition to the chemical compound of the hydrogen cation and the hydroxide anion from the water. Polyester polymers in general, and polyesters made from renewable sources including PLA in particular, are susceptible to hydrolysis, which breaks down chemical bonds in the polymer chains resulting in the progressive degradation of the polymer and of members made therefrom when exposed to moisture. While this degradability is desirable for items that are intended to be biodegradable after a short period of use, it is completely unacceptable for members used for window and door components and other building products. Such members must withstand exposure to the elements for extended periods of time without degrading. Accordingly, if PLA or other biopolymers are to be used to fabricate such members, their natural tendency to degrade through hydrolysis must be inhibited. The inventors have discovered that this can be accomplished as described in the following discussion.

As used in this discussion, the term “hydrolytic stability” of a polymeric material refers to the degree to which the material retains its mechanical properties under hydrolytic conditions. “Hydrolytic conditions” refers to exposure to elevated temperature and humidity for an extended period of time. A mechanical property that is of particular interest for structural members, particularly for use as window and door components, is flexural strength which is related to flex modulus. This is because many of the loads encountered by various structural components of windows and doors are flexural in nature. Another set of properties of interest are those obtained by dynamic mechanical rheometry, namely storage modulus, loss modulus, and complex viscosity.

Hydrolysis can result in the loss of molecular weight of a polymer, along with accumulation of monomers and other lower molecular weight species. These changes can affect both the dynamic storage modulus and loss modulus of a member formed of the polymer. It has been found that the complex viscosity, which combines the effects of both dynamic storage modulus and loss modulus, is a particularly useful property for evaluating the effects of hydrolysis on a polymer. It has also been found that the complex viscosity correlates positively with flexural strength of a sample, while at the same time indicating the occurrence of hydrolysis prior to measurable loss in flexural strength. Thus, tracking complex viscosity versus a variety of other parameters can be a good indicator of the resistance of a polymer to the detrimental effects of hydrolysis.

It is well known that PLA is particularly susceptible to hydrolysis, especially when exposed to conditions of elevated temperature and humidity; conditions commonly encountered by window and door components and other building products. It is further known that the rate of hydrolysis can be reduced by blending carbodiimide-containing chemical compounds with the PLA. It has been discovered by the inventors, however, that composites containing PLA and wood fiber suitable for forming members exhibit a higher rate of hydrolysis than PLA alone. Further, when wood fiber is present, carbodiimide-containing chemical compounds are less effective in reducing the rate of hydrolysis. It has further been discovered that the addition of higher amounts of carbodiimide-containing chemical compounds can, to a significant degree, overcome the detrimental effects of the wood fiber on hydrolytic stability. These and other discoveries are described and disclosed in detail as follows.

Mechanical properties that are particularly sensitive to hydrolysis are the viscoelastic properties measured by dynamic mechanical testing. These properties include G′, or storage modulus, G″, or loss modulus, and η*, or complex viscosity. It has been found that changes in these properties due to hydrolysis can occur and be detectable before deterioration in other mechanical properties, such as flexural strength, become detectable. Accordingly, in order to investigate hydrolysis induced degradation of mechanical properties in members formed of PLA, dynamic testing of specimens was conducted by the inventors using a Rheometrics RDA II Dynamic Analyzer, which is a parallel plate rheometer available from Rheometrics, Inc., Piscataway, N.J. This instrument controls the temperature of a specimen being tested while subjecting it to an oscillating stress over a range of frequencies. Specimens can be tested at different temperatures and the temperature data shifted, according to the principle of time-temperature superposition, to form a master curve that can be used to predict sample properties at other temperatures. This process is described, among other places, in standard textbooks on the rheology of polymers (See e.g. Rosen, Steven L., Fundamental Properties Of Polymeric Materials, Wiley Interscience, LC TA 455.P58R63, ISBN 0-471-08704-1, pp. 256-263 and pp 272-276, which is hereby incorporated by reference). Alternatively, a single test temperature can be chosen as the standard temperature, and data produced for different specimens tested at that temperature can be compared. Similarly, testing over a range of frequencies of oscillation applied to a specimen can provide a great deal of useful information. Also, comparing test results from specimens at a single testing frequency can also provide useful information, especially when comparisons of properties of different samples tested at that frequency can be made.

The properties of G′, G″, and η* are related as follows:

η*=[G′²+G″²]^{1/2}/f

It has been discovered to be particularly insightful to investigate the value of η* at f=10 Hertz as a measure of hydrolysis effects in a biopolymer. Values of η* at this frequency appear to be particularly sensitive to changes in material properties due to hydrolysis and material decomposition, and choosing a single frequency simplifies comparison of test results. Moreover, since η* includes both elastic and viscous effects, it provides a good indication of changes in overall mechanical properties, due, for example, to changes in formulation or processing.

In view of the foregoing, the inventors conducted a variety of tests designed to assess hydrolysis in a variety of different compositions, and to investigate ways to improve hydrolysis in such compositions. More specifically, various samples were exposed to high temperature and humidity conditions for a variety of lengths of time, after which the samples were tested. The following Tables 12-14 tabulate information referred to below in describing the testing methodology employed by and discoveries made by the inventors when investigating hydrolysis in compositions containing PLA. Table 12 shows the base formulation of a PLA-wood composite used for the testing described below. It will be noted that this formulation is based upon the formulation used in Samples 19-22 above that demonstrated good HDT performance when extruded under favorable conditions. This formulation was varied by including or excluding wood fiber and by adding various weight percentages of hydrolysis inhibitors, and the resulting variants were subjected to the testing and analysis detailed below. Table 13 tabulates testing results for a number of variants of the basic formulation, including formulations without any wood fiber or other fillers, and Table 14 shows two PLA-wood composite formulations made to test the impact of including different quantities of a hydrolysis inhibitor containing a carbodiimide, in this case Stabaxol I which is a monomeric carbodiimide made by Rhein Chemie of Chardon, Ohio, to the formulation. Other carbodiimide containing compounds may also be useful, such as Stabaxol I LF, which is a monomeric compound containing carbodiimide groups, and Stabaxol P, which is a polymeric material containing carbodiimide groups, both also made by Rhein Chemie. Other compounds that contain carbodiimide groups and that are known to have stabilizing effects on polyesters are disclosed in U.S. Pat. No. 5,210,170 and U.S. Pat. No. 5,614,483, both incorporated herein by reference, U.S. published patent application 2010/0093888A1, which discloses carbodiimide compounds particularly suited for stabilization of PLA, is also incorporated herein by reference. Polymeric materials containing carbodiimide groups that are known to have a stabilizing effect on polyesters are disclosed in U.S. Pat. No. 6,498,225, also incorporated herein by reference. When carbodiimide groups of a chemical compound react with the carboxylic acid groups on the polymer or with water, it gives rise to urea compounds as discussed in Rhein Chemie product literature PL351/0.5 T/sc/0910, incorporated herein by reference.

TABLE 12
Formulation of Samples 31 and 32

| COMPONENT | wt % |
|---|---|
| 4032D PLA | 55 |
| WOOD FIBER | 40.0 |
| XL-623 | 2.0 |
| CALCIUM | 1.0 |
| STEARATE | |
| TALC | 1.0 |
| LAK-301 | 1.0 |

TABLE 13
Formulation of and Test Results for Samples 33-38

| | | | | | | | | HOURS TO | |
|---|---|---|---|---|---|---|---|---|---|
| | wt % | wt % | | | | | | REACH | HOURS TO |
| SAM- | 4032D | WOOD | wt % | wt % Ca | wt % | wt % | wt % | 50% OF | REACH |
| PLE | PLA | FIBER | XL-623 | STEARATE | TALC | LAK-301 | STABAXOL I | INITIAL n* | n* = 0 |
| 33 | 94.0 | 0.0 | 2.0 | 1.0 | 1.0 | 1.0 | 1.0 | 75 | 100 |
| 34 | 54.0 | 40.0 | 2.0 | 1.0 | 1.0 | 1.0 | 1.0 | 30 | 70 |
| 35 | 92.5 | 0.0 | 2.0 | 1.0 | 1.0 | 1.0 | 2.5 | 160 | 380 |
| 36 | 52.5 | 40.0 | 2.0 | 1.0 | 1.0 | 1.0 | 2.5 | 35 | 70 |
| 37 | 90.0 | 0.0 | 2.0 | 1.0 | 1.0 | 1.0 | 5.0 | 180 | N/A |
| 38 | 50.0 | 40.0 | 2.0 | 1.0 | 1.0 | 1.0 | 5.0 | 50-115 | 325 |

TABLE 14
Formulation of Samples 39-40

| | wt % | wt % | | | | | |
|---|---|---|---|---|---|---|---|
| SAM- | 4032D | WOOD | wt % | wt % Ca | wt % | wt % | wt % |
| PLE | PLA | FIBER | XL-623 | STEARATE | TALC | LAK-301 | STABAXOL I |
| 39 | 52.5 | 40.0 | 2.0 | 1.0 | 1.0 | 1.0 | 2.5 |
| 40 | 50.0 | 40.0 | 2.0 | 1.0 | 1.0 | 1.0 | 5.0 |

### Sample 31

### Test Validation A

To produce Sample 31, a member having a rectangular profile was extruded from the PLA-wood composite of Table 12 using the production scale Davis Standard twin screw extruder described above. Sample 31 did not have a capping layer. The extruded member was cooled using about 10° to 16° Celsius (50° to 60° Fahrenheit) water.

### Sample 32

### Test Validation B

To produce Sample 32, a member having a rectangular profile was extruded from the PLA-wood composite of Table 12 using the production scale Davis Standard twin screw extruder described above. Sample 32 included the capping material described in Table 10 co-extruded over the PLA-wood composite base extrusion.

Disk-shaped control specimens were cut from the sides of the resulting extruded member of both Samples 31 and 32 prior to exposure to any elevated temperatures or humidities. These specimens were tested using the RDA II Dynamic Analyzer at temperatures ranging from about 140° Celsius to about 240° Celsius. The temperature data was shifted using shift factors that produced a continuous master curve of η* as a function of frequency, as prescribed by the Boltzman principle of time-temperature superposition. The value of η* at 10 Hertz was selected as the standard for comparison among samples. The results from this testing provided control data that the various test conditions described below were compared against.

Additional specimens cut from the various samples were placed in environmental test chambers and exposed to a number of combinations of environmental conditions including temperatures of 78° Celsius and 88° Celsius (172° Fahrenheit and 190° Fahrenheit′ and relative humidity of 25%, 79%, and 90%, for time periods of 24, 48, and 96 hours. There were 18 permutations of these conditions, and different specimens were exposed to each of the permutations. These specimens were then tested using the RDA II Dynamic analyzer in the same manner as the control specimens.

Strips of material were also cut from the sides of the extruded members and exposed to the same combinations of temperature and humidity conditions for the same times as used for the disk-shaped specimens. These strip-shaped specimens were tested for flexural strength according to ASTM D 790-03. Tests for flexural strength, which produced flexural modulus data, were run for each specimen until the specimen failed, and the stress in the most highly stressed element of the specimen at failure was calculated using Instron Series IX software. The unexposed control specimens were also tested for flexural strength in the same manner. The results and discoveries resulting from the testing are discussed below.

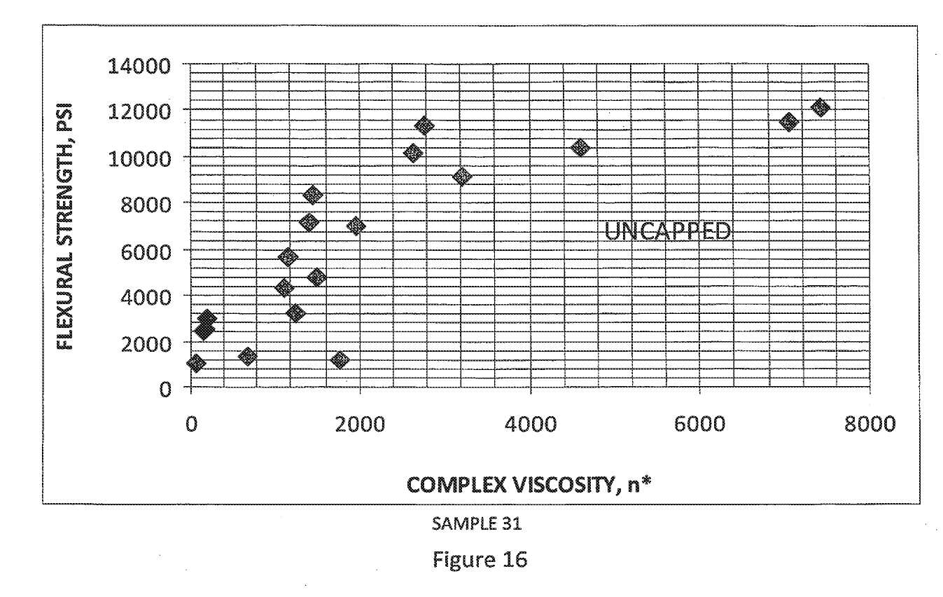

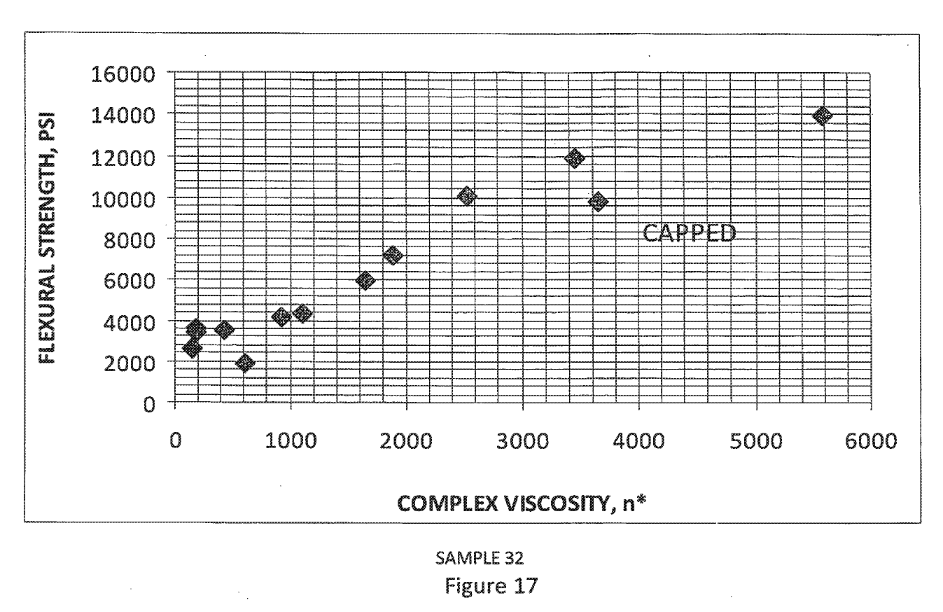

FIG. 16 is a graph showing flexural strength plotted against complex viscosity η* for samples without capping extruded from the formulation of Table 12 and exposed to the 18 permutations of temperature, humidity, and exposure time conditions described above. More specifically, the measured flexural moduli for the various levels of exposure to temperature and humidity are plotted against the corresponding values of η*. As can be seen in FIG. 16, for values of η* above 3000 Pa-sec (Pascal-seconds), relatively large changes in η* can occur with a relatively small effect on flexural strength. The higher values of η* correspond to shorter exposure times, lower relative humidity, and lower temperatures. Values of η* below 3000 indicate more significant deterioration in properties, as indicated by the corresponding decrease in flexural strength. While the inventors do not wish to be bound by any particular theory as to why heat and humidity appear to cause deterioration in both η* and flexural strength, it seems reasonable that since the factors driving the decrease in mechanical properties are elevated temperature and humidity, and since PLA is known to be highly susceptible to hydrolysis, it is likely that hydrolysis is a major cause of the deterioration, and that dynamic mechanical testing to obtain η* is a valid method for measuring this phenomenon.

### Samples 33 to 38

Samples 33 to 38 were prepared by adding the ingredients specified in Table 13 at the corresponding weight percents to a Brabender fusion bowl. The molten material from the fusion bowl was transferred to a Wabash press, where it was compressed into a sheet having a thickness of about 0.1 inches. After cooling, specimens in the form of disks having a diameter of about 1.0 inches were cut from the sheet, using a standard hole punch. These disks were used for dynamic mechanical analysis, to determine η* for the samples. In specimens wherein flexural strength or heat distortion temperature were to be measured, appropriately dimensioned strips were also cut from the pressed sheet. This method of specimen preparation was used for all samples that used the Brabender fusion bowl. Some of the specimens were kept at room temperature and humidity for use as control specimens, while other specimens were exposed to the various permutations of elevated temperature and humidity and exposure times prior to testing as described above. Testing results for the samples will now be discussed in more detail with reference to the corresponding tables and figures.

### Sample 33

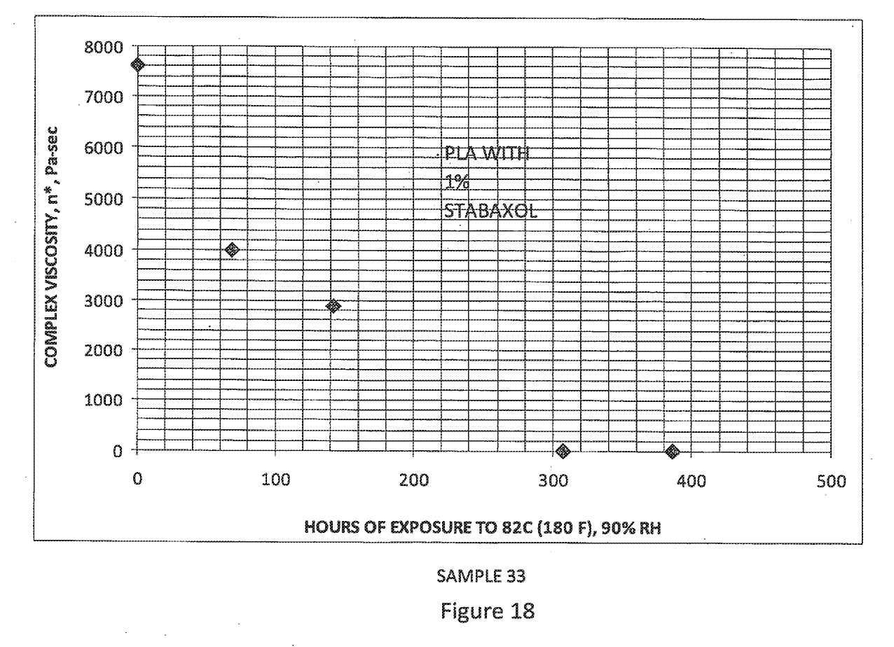

For Sample 33, no wood fiber was added to the mixture meaning that the sample comprised a neat PLA formulation with the weight percents of additives as indicated in Table 13. The test batch was prepared in the Brabender fusion bowl and pressed into a sheet as detailed above. Specimens were cut from the sheet and placed in a closed environmental chamber at 88° Celsius (190° Fahrenheit) and 90% relative humidity for an extended period of time. Specimens were removed from the environmental chamber after various pre-selected exposure times and the value of complex viscosity η* was measured in the Dynamic Mechanical Analyzer. The results are illustrated in FIG. 18. The data demonstrate that η* decreases as exposure times increase, as would be expected since elevated temperature and humidity promotes hydrolysis. Even though significant hydrolysis occurs within only a few hours, it is seen that after about 75 hours, Sample 33 still retains about 50% of its original value, as represented by η* for the control specimen plotted at zero hours in FIG. 18. Beyond 75 hours, Sample 33 still exhibits significant values of η* for up to 100 hours or more, and η* does not reach zero until about 300 hours of exposure.

### Sample 34

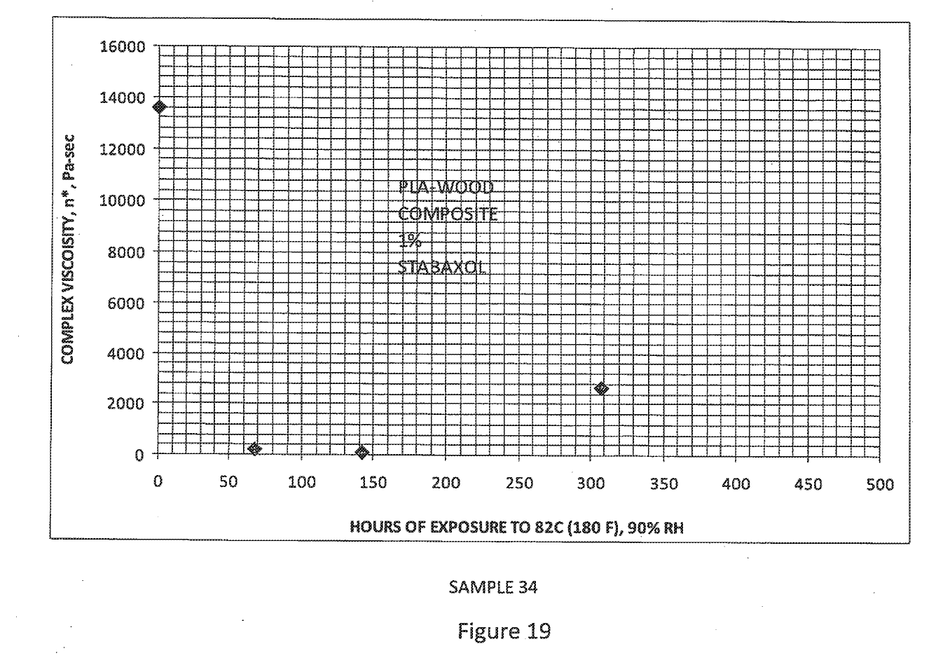

Sample 34, which includes 40 wt % wood fiber, was prepared in the Brabender fusion bowl as described. Specimens were exposed to 88° Celsius (190° Fahrenheit) and 90% relative humidity in the same manner as were the specimens of Sample 33, which did not contain wood fiber. Specimens were removed from the test chamber after specified periods of exposure and tested to determine η*. As seen from the resulting data presented in FIG. 19, η* declined to 50% of its original value after only about 30 hours of exposure, and fell to almost zero, indicating complete hydrolysis, after only about 70 hours. It therefore became clear to the inventors that the presence of wood fiber has a detrimental effect on the hydrolytic stability of PLA.

### Sample 35

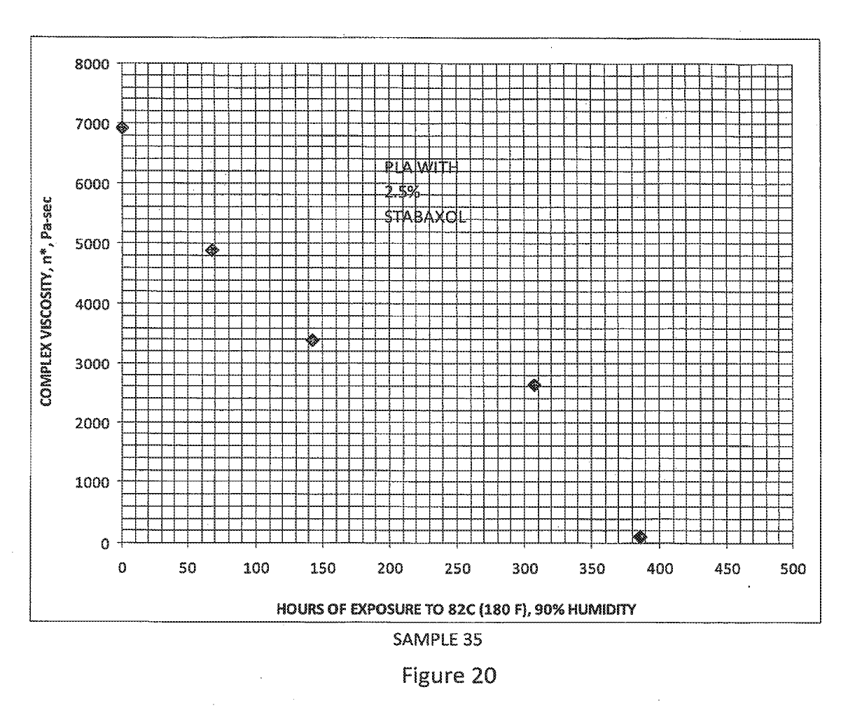

Sample 35 is a neat PLA formulation with the additives indicated in Table 13, including 2.5 wt Stabaxol I. Testing of specimens exposed to 82° C. (180° F.) and 90% humidity produced the results shown in FIG. 20. As can be seen when compared to Sample 33, the increased Stabaxol I percentage increased the time for η* to drop to 50% of its original value to 160 hours, as well as increasing the time until complete hydrolysis to about 380 hours. Accordingly, increasing the percentage of Stabaxol I in a neat PLA formulation increases the resistance of PLA to hydrolysis and the consequent deterioration of the PLA.

### Sample 36

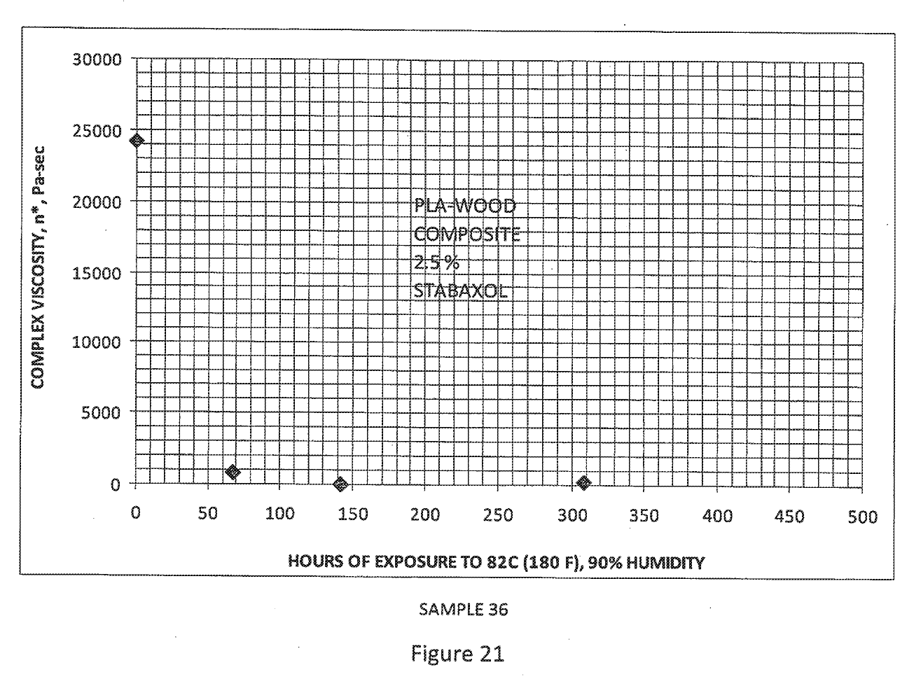

Sample 36 is a PLA-wood composite with the additives indicated in Table 13, including 2.5 wt % Stabaxol I. Sample 36 was tested as described and the resulting data is shown in FIG. 21. Again, it is seen that the addition of the wood fiber has a detrimental effect on hydrolytic stability, since the value of η* drops to 50% of its original value in only about 35 hours, and the sample undergoes complete hydrolysis in only 70 hours.

### Samples 37 and 38

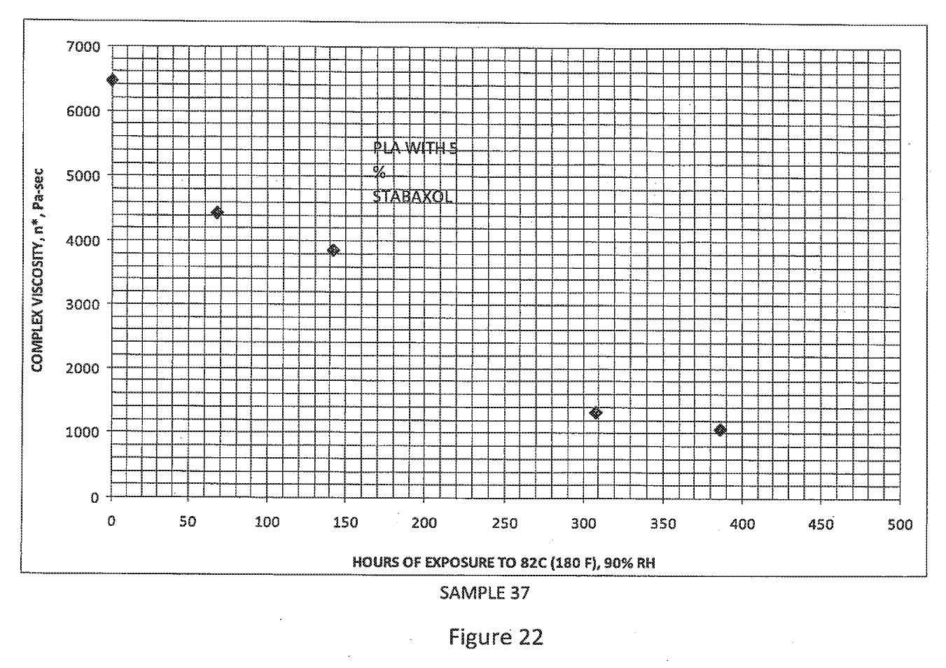

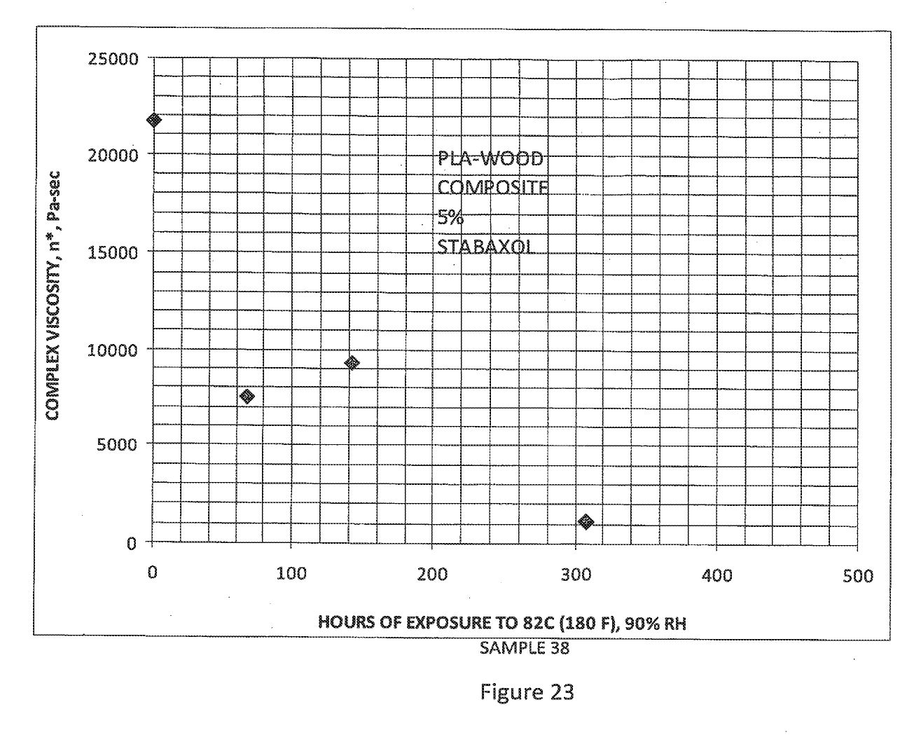

In order to explore further the impact of a hydrolysis inhibitor, and Stabaxol I in particular, on hydrolysis of a PLA composition, samples were prepared having the formulations indicated for Samples 37 and 38 in Table 13. Noteworthy is the fact that for these samples, a significantly larger 5 wt % of Stabaxol I was added to the mixture. Specimens made from these samples where then exposed to the environmental conditions described above and tested after specified periods of exposure. The resulting data are summarized in FIGS. 22 and 23 respectively. It appears clear from this data that the addition of 5% Stabaxol I yields further improvement in hydrolytic stability of a neat PLA formulation and a PLA-wood composite. However, as seen in FIG. 23, the addition of wood fiber still has a detrimental effect on hydrolytic stability, even with such large amounts of the hydrolysis inhibitor Stabaxol I.

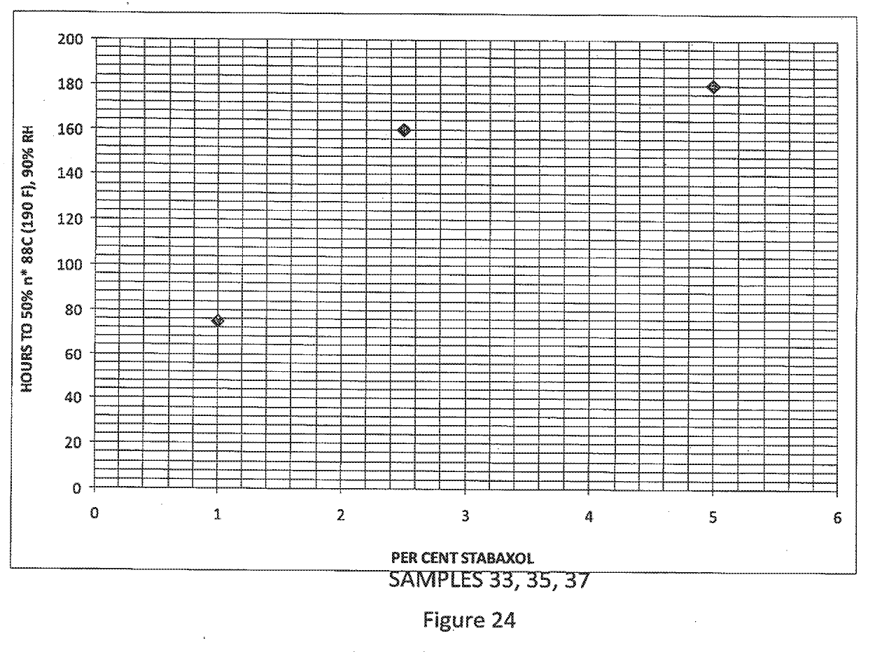

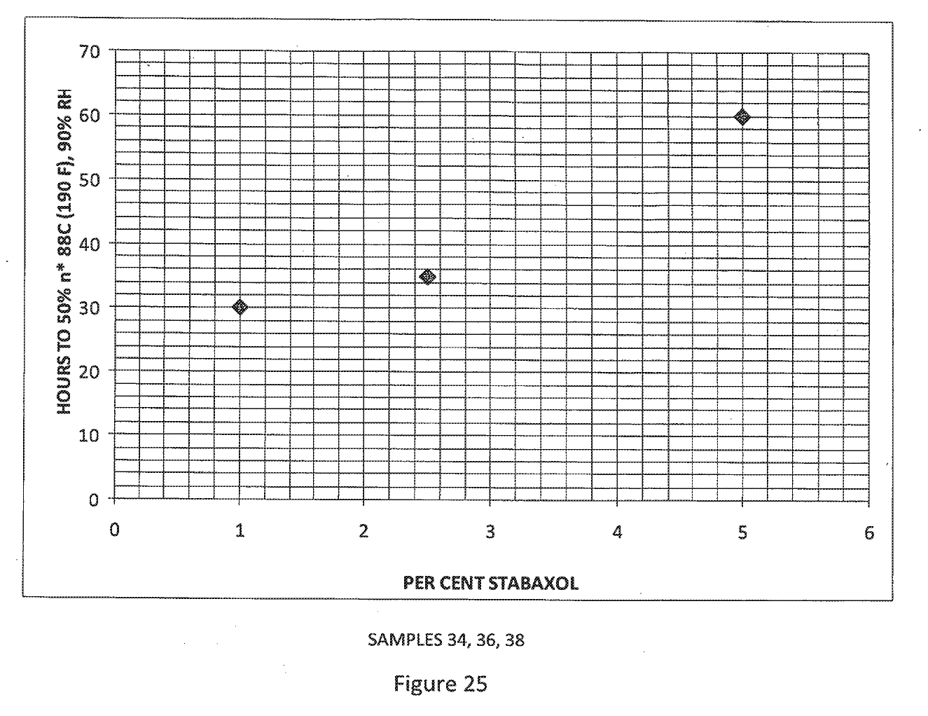

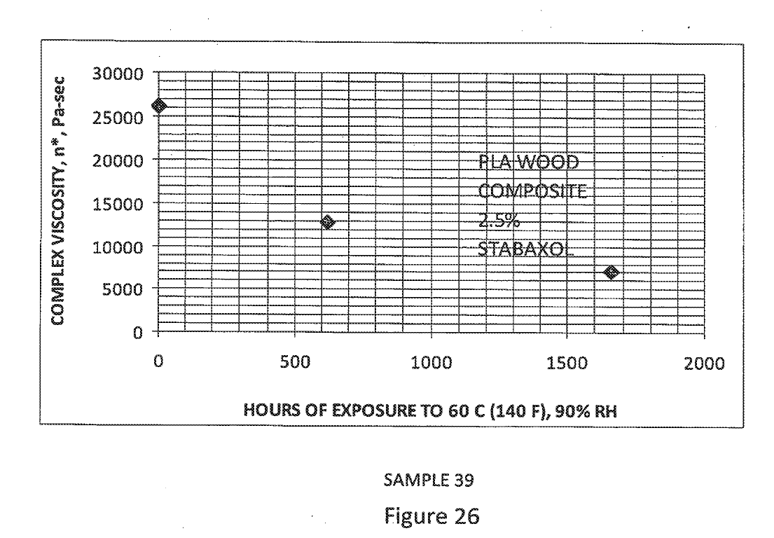

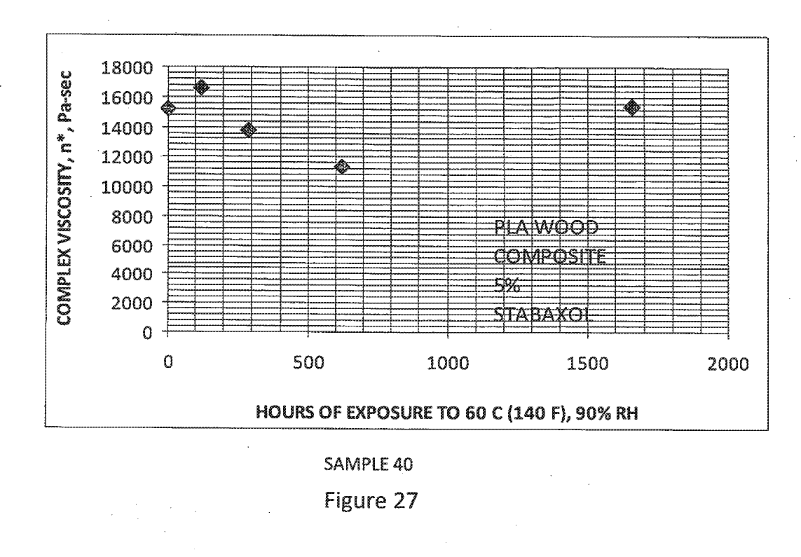

FIG. 24 plots the hours of exposure of the neat PLA formulations of Samples 33, 35 and 37 to 88° Celsius (190° Fahrenheit) and 90% relative humidity needed for η* to reach 50% of its original value as a function of the amount of the wt % Stabaxol I in the formulation. This data indicates that the addition of Stabaxol I improves hydrolytic stability up to a certain wt %, but rapidly exhibits diminishing improvement thereafter. In other words, the slope of the curve decreases with increasing Stabaxol I content in FIG. 24. The point of diminishing improvement appears to be between 2 and 3 wt %, and more specifically around 2.5 wt % Stabaxol I. While the inventors do not wish to be bound by any particular theory as to why this effect might occur, it would seem consistent with a chemical model in which the Stabaxol I protects certain vulnerable sites on the PLA polymer from hydrolytic reactions, and once enough Stabaxol I has been added to protect most, if not all of the sites, adding more Stabaxol I has little or no further effect.

FIG. 25 plots the hours of exposure of the PLA-wood composites of Samples 34, 36, and 38 to 88° Celsius (190° Fahrenheit) and 90% relative humidity needed for η* to decrease to 50% of its original value is plotted as a function of the amount of Stabaxol I present in the formulation. The data indicate that, surprisingly, the positive effect of the Stabaxol I actually increases significantly after about 2.5 wt % with increasing amounts of Stabaxol I added. This is indicated by the increasing slope of a curve through the data points of FIG. 25. This effect is the opposite of that seen in FIG. 24, wherein wood fiber was not present in the sample. While surprising, the increasing effect could be consistent with a chemical model in which the Stabaxol I not only reacts with the PLA to inhibit hydrolysis, but also reacts with or attaches to the wood fiber, thereby reducing the amount of the Stabaxol I available to protect the PLA from hydrolysis. In such a model, the Stabaxol I does not attach to all of the potential hydrolysis sites of the PLA molecules even at 5 wt because much of the Stabaxol I is absorbed by the wood fibers. The addition of more Stabaxol I therefore continues to improve the hydrolysis resistance of the composite.

### Samples 39 and 40

In Samples 39 and 40, samples of a PLA-wood composite with 2.5% and 5% respectively of Stabaxol I in addition to the other ingredients indicated in Table 14 were exposed to less severe temperature and humidity conditions. More specifically, specimens from these samples were exposed in an environmental chamber to temperatures of about 60° Celsius (140° Fahrenheit) at about 90% relative humidity for various preselected periods of time and then tested as described above. The results for each sample are shown in FIGS. 26 and 27 respectively. Referring to FIG. 26, it can be seen that with the addition of Stabaxol I to the formulation in an amount of about 2.5 wt %, the value of η* reaches 50% of its initial value after about 624 hours. It was previously found, in other tests, that a PLA-wood composite without Stabaxol I reached 50% of its initial value after about 92 hours. Thus, the addition of 2.5% Stabaxol I improved the time to 50% of the original value of η* by a factor of about 6.8. Higher levels of Stabaxol I are even more effective. As seen in FIG. 27, 5% Stabaxol I appears to be effective in preventing η* from dropping to 50% of its original value, even after about 1656 hours, an improvement factor of at least 18. In fact, the data indicates that the integrity of the samples actually increases somewhere between 720 and 1680 hours of exposure, which is indeed surprising. Thus, it appears to be viable that a PLA composition can be formulated that will exhibit a level of hydrolysis resistance sufficient to allow the composition to be used in members to be exposed to the environment for extended periods of time.

TABLE 15

| | wt % | wt % | wt % | |
|---|---|---|---|---|
| | PLA | ACRYLIC | WOOD | HDT |
| SAMPLE | 4032D | H300 | FIBER | ° C. |
| 41 | 75 | 25 | 0 | 139 |
| 42 | 45 | 15 | 40 | 122 |

Biopolymers can also be blended with other polymers, including those that are petroleum based polymers. One example would be blending PLA with an acrylic. Such polymer blends can also be further blended with fillers such as wood fiber to form useful composites, as illustrated by Samples 41 and 42 in Table 15. Referring to the formulations of Table 15, PLA 4032D was blended with Solarkote H300 acrylic polymer, available from Arkema, Inc., 2000 Market Street, Philadelphia, Pa., to form Samples 41 and 42. Compounding was done in the Brabender fusion bowl, and the compounded material pressed into a sheet, according to the method described hereinabove for Samples 33-38. Heat distortion temperature was measured by cutting strips from the pressed sheet and subjecting these strip-shaped specimens to the heat distortion test also described hereinabove.

### Sample 41

In Sample 41, a blend of 75% NatureWorks PLA and 25% Solarkote H300 was formed in the Brabender fusion bowl and pressed into a sheet. Strips were cut from the sheet and tested for heat distortion. The heat distortion temperature was found to be 139° C., a value comparable to well crystallized PLA-wood composites.

### Sample 42

In Sample 42, a blend of 45% NatureWorks PLA, 15% Solarkote H300, and 40% wood fiber was formed and pressed into a sheet. Strips were cut from the sheet and tested for heat distortion. The heat distortion temperature was found to be 122° C., a value comparable to well crystallized PLA-wood composites.

As described previously, an additional cold crystallization process can be used to further increase the crystallinity of a previously processed member. Samples 43 and 44 demonstrate the impact of an additional cold crystallization process on the compositions described above. In addition, these samples demonstrate the impact of a capping layer on the hydrolysis resistance of the PLA-wood composite base extrusion.

### Sample 43

To produce Sample 43, the profile shown in FIG. 3 was extruded using the PLA-wood composite specified in Table 12 using the fast cooling rate. The resulting HDT for specimens from Sample 43, prior to cold crystallization, was 50° C. Specimens from Sample 43 having a length of 6 inches were then held at 94° C. for 20 minutes, to increase the crystallinity. After this additional cold crystallization process, these specimens were tested and the resulting HDT increased to 107° C., HDT values consistent with a high level of crystallinity. Both ends of the sample were plugged with about 1 inch of closed-cell foam that was sealed to the member with a polyurethane adhesive to prevent air flow to the hollow region of the sample. The plugged sample was then exposed to 78° Celsius (172° F.) and 79% RH for up to 96 hours, with specimens being removed at various intervals for testing using dynamic mechanical analysis. It was found that the value of complex viscosity (η*) declined to 50% of its original value after approximately 20 hours of exposure to 78° Celsius (172° F.) and 79% RH. This sample shows the potential to increase crystallization of compositions through an additional cold crystallization process.

### Sample 44

To produce Sample 44, the profile shown in FIG. 4 was extruded using the PLA-wood composite specified in Table 12 using the fast cooling rate. A capping material, shown in Table 10, was co-extruded over the PLA-wood composite base extrusion. The resulting HDT for specimens from Sample 44, prior to cold crystallization, was 53° C. Specimens from Sample 44 having a length of 6 inches were then held at 94° C. for 20 minutes, to increase the crystallinity. After this additional cold crystallization process, these specimens from Sample 44 were tested and the resulting MDI′ increased to 107° C., HDT values consistent with a high level of crystallinity. In addition, both ends of the sample were plugged with about 1 inch of closed-cell foam that was sealed to the member with a polyurethane adhesive to prevent air flow to the hollow region of the sample. The plugged sample was then exposed to 78° Celsius (172° F.), and 79% RH for up to 96 hours, with specimens being removed at various intervals for testing using dynamic mechanical analysis. It was found that the value of complex viscosity (η*) declined to 50% of its original value after approximately 40 hours of exposure to the 78° Celsius (172° F.), 79% RH. Comparing this result with Sample 43, it was apparent that the capping layer increased the hydrolytic stability by a factor of 2. It is believed that at least some of this improvement was due at least in part to the reduction in moisture transport through the capping layer to the PLA-wood composite.

Although it has been found that a preferred ratio of weight percent PLA to weight percent filler such as wood fiber is between about 50/40 and 60/40 depending upon the weight percentages of the other additives used, the ratio of PLA to filler can be varied to achieve a wide variety of properties. Samples 45 to 48 demonstrate the wide range of properties that can be achieved.

### Sample 45

Sample 45 is a PLA-wood composite containing only 40% NatureWorks 4032D polylactic acid and 60% wood fiber prepared as described hereinabove using the fusion bowl and pressing method. Specimens from Sample 45 were tested for heat distortion temperature and flexural strength, with the results shown in Table 16.

### Sample 46

Sample 46 is a PLA-wood composite containing only 25% NatureWorks 4032D polylactic acid and 75% wood fiber prepared as described hereinabove using the fusion bowl and pressing method. Specimens from Sample 46 were tested for heat distortion temperature and flexural strength, with the results shown in Table 16.

### Sample 47

Sample 47 is a PLA-wood composite having the composition shown in Table 12 prepared as described hereinabove using the fusion bowl and pressing method, as in Samples 45 and 46. Specimens from Sample 47 were tested for heat distortion temperature and flexural strength with the results shown in Table 16.

### Sample 48

A neat PLA formulation containing 95% NatureWorks 4032D PLA, 2% XL-623, 1% Calcium stearate, 1% talc, and 1% LAK-301 was blended in a Brabender extruder and extruded into a strip, with a medium cooling rate, as described hereinabove. Specimens from Sample 48 were tested for heat distortion temperature with the results shown in Table 16.

TABLE 16

| | | FLEXURAL | |
|---|---|---|---|
| | wt % | STRENGTH | HEAT DISTORTION |
| SAMPLE | WOOD FIBER | PSI | TEMPERATURE, ° C. |
| 45 | 60 | 7815 | 133 |
| 46 | 75 | 3110 | 149 |
| 47 | 40 | 7573 | 136 |
| 48 | 0 | — | 109 |

Referring to Table 16, it is seen that wood fiber loadings in the range of 40% to 60% provide substantially the same levels of flexural strength and heat distortion temperature. Higher levels of wood loading, as seen in Sample 46, however, show a significantly lower flexural strength, even though the heat distortion temperature was higher. This demonstrates that while a wood fiber loading of 40% is convenient and useful and may be preferred in many situations, higher wood loadings can also produce useful composites. Moreover, as demonstrated by Sample 48, in the absence of any filler, a suitable combination of nucleating agents can, depending on cooling conditions, produce heat distortion temperatures comparable to those exhibited by some PLA-wood composites.

The inventions and discoveries contained in the foregoing descriptions have been presented within the context of neat PLA formulations and PLA-wood composites and of extrusion and compression molding of such materials under a variety of specific processing and cooling conditions. It will be understood by the skilled artisan, however, that the inventions and discoveries are not limited to these or any other specific scenarios. Indeed, the findings presented herein apply to other biopolymers and more broadly to other fermentation-based polymers. Petroleum based polymers can be mixed with PLA or other biopolymers according to specific requirements of an application. Thus, while 100% biopolymer is preferred, the inventions and discoveries are intended to cover biopolymer and petroleum based polymer mixtures. Wood fiber is presented in the exemplary embodiments as the preferred filler. However, other fillers such as other organic or inorganic materials should be considered to be within the scope of the inventions and discoveries. Profile extrusion is presented as the preferred method of forming a neat PLA formulation or PLA-wood composite into members. This is not limiting however. Other fabrication techniques such as compression molding and sheet molding also might be employed within the scope of the inventions and discoveries. The capping materials presented above are conventional capping materials, but any capping material might be employed within the scope of the inventions and discoveries. These and other additions, deletions, and modifications, both subtle and gross, might well be made to the exemplary embodiments presented above without departing from the spirit and scope of the invention, which is encompassed by the claims.

What is claimed is:

1. A method of forming a member comprising the steps of:
(a) obtaining a biopolymer and a filler;
(b) feeding the biopolymer and the filler to an extruder;
(c) controlling at least the temperature of the biopolymer and the filler within the extruder to promote the initiation of nucleation of the biopolymer;
(d) forcing the biopolymer and the filler through a die of the extruder to form an extruded member; and
(e) controlling at least the cooling rate of the extruded member after it leaves the die to promote crystallization of the biopolymer.

2. A method of forming a member as claimed in claim 1 and wherein the step (b) includes the mixing together of the biopolymer and the filler within the extruder to form the composite.

3. A method of forming a member as claimed in claim 1 and further comprising the step following step (a) of compounding the biopolymer and the filler to form a composite having a predetermined weight percent biopolymer and a predetermined weight percent filler and wherein step (b) comprises feeding the compounded composite to the extruder.

4. A method of forming a member as claimed in claim 3 and further comprising the step of pelletizing the compounded composite before step (b) and wherein step (b) comprises feeding the pelletized composite to the extruder.

5. A profile extrusion process comprising:
feeding polylactic acid and at least one nucleating agent to an extruder to form a mixture;
moving the mixture through a profile extrusion die to form a base extrusion; and
providing conditions effective to crystallize the polylactic acid during the profile extrusion process.

6. The method of claim 5 further comprising providing conditions effective to initiate nucleation of the polylactic acid before the mixture exits the profile extrusion die.

7. The method of claim 6 wherein providing conditions effective to initiate nucleation of the polylactic acid comprises controlling the melt temperature of the polylactic acid before the mixture exits the profile extrusion die.

8. The method of claim 5 wherein providing conditions effective to crystallize the polylactic acid comprises controlling the cooling conditions to maintain the temperature of the base extrusion after exiting the profile extrusion die within a predetermined temperature range for a predetermined length of time.

9. The method of claim 8 wherein the predetermined temperature range is from 100 degrees Celsius to 120 degrees Celsius.

10. The method of claim 8 wherein the predetermined length of time is 20 seconds to 275 seconds.

11. The method of claim 5 wherein the at least one nucleating agent comprises an organic nucleating agent, an inorganic nucleating agent, or a combination thereof.

12. The method of claim 5 wherein feeding polylactic acid and at least one nucleating agent to an extruder to form a mixture comprises feeding polylactic acid, a filler, and at least one nucleating agent to an extruder to form a mixture.

13. The method of claim 12 wherein the filler comprises wood particulate.

14. The method of claim 12 wherein feeding polylactic acid, a filler, and at least one nucleating agent to an extruder to form a mixture comprises feeding a compounded composite of two or more components to the extruder, wherein the components comprise polylactic acid, a filler, and at least one nucleating agent.

15. The method of claim 14 wherein the compounded composite is in the form of pellets.

16. The method of claim 14 wherein the method further comprises:
compounding polylactic acid, a filler, and at least one nucleating agent in determined weight percentages to form a compounded composite;
wherein feeding polylactic acid, a filler, and at least one nucleating agent to an extruder to form a mixture comprises feeding the compounded composite to the extruder.

17. The method of claim 16 wherein the method further comprises:
pelletizing the compounded composite;
wherein feeding polylactic acid, a filler, and at least one nucleating agent to an extruder to form a mixture comprises feeding the pelletized compounded composite to the extruder.

18. The method of claim 5 further comprising moving a capping material through an extrusion die onto at least part of the base extrusion.

19. The method of claim 18 wherein moving a capping material through an extrusion die onto at least part of the base extrusion occurs during or after formation of the base extrusion.

20. The method of claim 5 wherein feeding polylactic acid and at least one nucleating agent to an extruder to form a mixture comprises feeding polylactic acid, a hydrolysis inhibitor, and at least one nucleating agent to an extruder to form a mixture.

21. The method of claim 20 wherein the hydrolysis inhibitor comprises a carbodiimide.

22. The method of claim 5 wherein feeding polylactic acid and at least one nucleating agent to an extruder to form a mixture comprises feeding polylactic acid, a filler, a hydrolysis inhibitor, and at least one nucleating agent to an extruder to form a mixture.

23. The method of claim 22 wherein feeding polylactic acid, a filler, a hydrolysis inhibitor, and at least one nucleating agent to an extruder to form a mixture comprises feeding a compounded composite of two or more components to the extruder, wherein the components comprise polylactic acid, a filler, a hydrolysis inhibitor, and at least one nucleating agent.

24. The method of claim 5 further comprising devolatilizing prior to moving the polylactic acid and at least one nucleating agent through an extrusion die.

25. A profile extrusion process comprising:
feeding polylactic acid and at least one nucleating agent to an extruder to form a mixture;
moving the mixture through a profile extrusion die to form a base extrusion;
controlling the melt temperature of the polylactic acid before the mixture exits the profile extrusion die; and
controlling the cooling conditions to maintain the temperature of the base extrusion after the profile extrusion die within a temperature range from 100 degrees Celsius to 120 degrees Celsius for 20 seconds to 275 seconds.
